(19) United States
(12) Patent Application Publication
(10) Pub. No.: US 2010/0128432 A1
(43) Pub. Date: May 27, 2010

(54) SYSTEM AND METHOD FOR VIRTUAL COMPUTING ENVIRONMENT MANAGEMENT, NETWORK INTERFACE MANIPULATION AND INFORMATION INDICATION

(76) Inventor: Matthew P. MILLER, Great Falls, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/485,839

(22) Filed: Jun. 16, 2009

Related U.S. Application Data
(60) Provisional application No. 61/061,931, filed on Jun. 16, 2008.
(60) Provisional application No. 61/097,083, filed on Sep. 15, 2008.

(51) Int. Cl. G06F 1/20; H05B 37/02

(52) U.S. Cl. 361/679.54; 315/294

(57) ABSTRACT

An apparatus for providing virtualization services is presented. According to an exemplary embodiment, the apparatus may include a middle chassis for containing one or more computing components for providing virtualization services, a top chassis for covering the middle chassis, where the top chassis includes a heat sink for conducting thermal energy away from the one or more computing components contained in the middle chassis, and where the top chassis is capable of being securely fastened to the middle chassis. The exemplary embodiment may further include a bottom chassis providing a base for the apparatus and a covering for the bottom of the middle chassis, where the bottom chassis includes a heat sink for conducting thermal energy away from the one or more computing components contained in the middle chassis, and where the bottom chassis is capable of being securely fastened to the middle chassis. The exemplary embodiment may further include a carrier board for securing one or more components, the carrier board communicatively coupling the one or more computing components and the carrier board being capable of being securely fastened to the middle chassis.

### CROSS-REFERENCE TO RELATED APPLICATIONS

This patent application claims priority to U.S. Provisional Patent Application No. 61/061,931, filed Jun. 16, 2008, which is hereby incorporated by reference herein in its entirety.

This patent application further claims priority to U.S. Patent Application No. 61/097,083, filed Sep. 15, 2008, which is hereby incorporated by reference herein in its entirety.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts an application interface for interfacing a virtualization management system with one or more hypervisors, in accordance with an exemplary embodiment.

FIG. 2 depicts an application interface for interfacing a virtualization management system with one or more hypervisors, in accordance with an exemplary embodiment.

FIG. 3 depicts an architecture for providing a user interface, business logic and business rules for a virtualization management system, in accordance with an exemplary embodiment.

FIG. 4a depicts a user interface for a virtualization management system, in accordance with an exemplary embodiment.

FIG. 4b depicts a user interface for a virtualization management system, in accordance with an exemplary embodiment.

FIG. 4c depicts a user interface for a virtualization management system, in accordance with an exemplary embodiment.

FIG. 5 depicts a user interface for a virtualization management system, in accordance with an exemplary embodiment.

FIG. 6a depicts a user interface for a virtualization management system, in accordance with an exemplary embodiment.

FIG. 6b depicts a user interface for a virtualization management system, in accordance with an exemplary embodiment.

FIG. 6c depicts a user interface for a virtualization management system, in accordance with an exemplary embodiment.

FIG. 7 depicts an exemplary embodiment of a hardware platform for virtualization.

FIG. 8 depicts an exemplary architecture for a carrier board for a hardware platform for virtualization.

FIG. 9 depicts exemplary connection locations for a hardware platform for virtualization.

FIG. 10 depicts an exemplary circuit diagram of a carrier board for a hardware platform for virtualization.

FIG. 11 depicts an exploded view of an exemplary hardware platform for virtualization.

FIG. 12 depicts another exploded view of an exemplary hardware platform for virtualization.

FIG. 13 depicts an exemplary top view of a hardware platform for virtualization.

FIG. 14 depicts an exemplary side view of a hardware platform for virtualization.

FIG. 15 depicts an exemplary top view of a hardware platform for virtualization.

FIG. 16 depicts an exemplary top-front view of a carrier board for a hardware platform for virtualization.

FIG. 17 depicts an exemplary top-rear view of a carrier board for a hardware platform for virtualization.

FIG. 18 depicts an exemplary front view of a carrier board for a hardware platform for virtualization.

FIG. 19 depicts an exemplary side view of a carrier board for a hardware platform for virtualization.

FIG. 20 depicts another exemplary side view of a carrier board for a hardware platform for virtualization.

FIG. 21 depicts another exemplary side view of a carrier board for a hardware platform for virtualization.

FIG. 22 depicts an exemplary top view of a carrier board for a hardware platform for virtualization.

FIG. 23 depicts an exemplary bottom view of a carrier board for a hardware platform for virtualization.

FIG. 24 depicts an exemplary view of a chassis of a hardware platform for virtualization.

FIG. 25 depicts a front view of an additional exemplary hardware platform for virtualization.

FIG. 26 depicts a rear view of an additional exemplary hardware platform for virtualization.

FIG. 27 depicts dynamic modification of physical network connectivity for a hardware platform, according to an exemplary embodiment.

FIG. 28 depicts a logical diagram for connecting information indicators, according to an exemplary embodiment.

FIG. 29a depicts an exemplary information indicator display format.

FIG. 29b depicts an exemplary information indicator display format.

FIG. 29c depicts an exemplary information indicator display format.

FIG. 30 depicts a logical diagram for connecting information indicators, according to an exemplary embodiment.

FIG. 31 depicts a bezel for mounting information indicators on a hardware platform, according to an exemplary embodiment.

FIG. 32 depicts exemplary information indicators associated with network ports.

### DETAILED DESCRIPTION OF PREFERRED EMBODIMENTS

As computing power increases, individuals and organizations may utilize virtualization technology to ensure efficient use of computing resources. Virtualization technology may facilitate consolidation of servers, may provide for increased uptime and redundancy of systems, and may enable containment of virtual servers. Consolidation of multiple systems may make managing and accessing a particular system more difficult. Administering the infrastructure as well as multiple virtual machines may be more difficult and less intuitive.

Additionally, some environments may find it desirable or necessary to run multiple virtualization platforms and/or multiple instances of the same virtualization platform. Running multiple virtualization platforms may increase the system management and administration complexity.

Furthermore, virtualization may provide consolidation but may require significant hardware and administration. The hardware and administration of a virtualization platform may limit some the flexibility that virtualization provides.

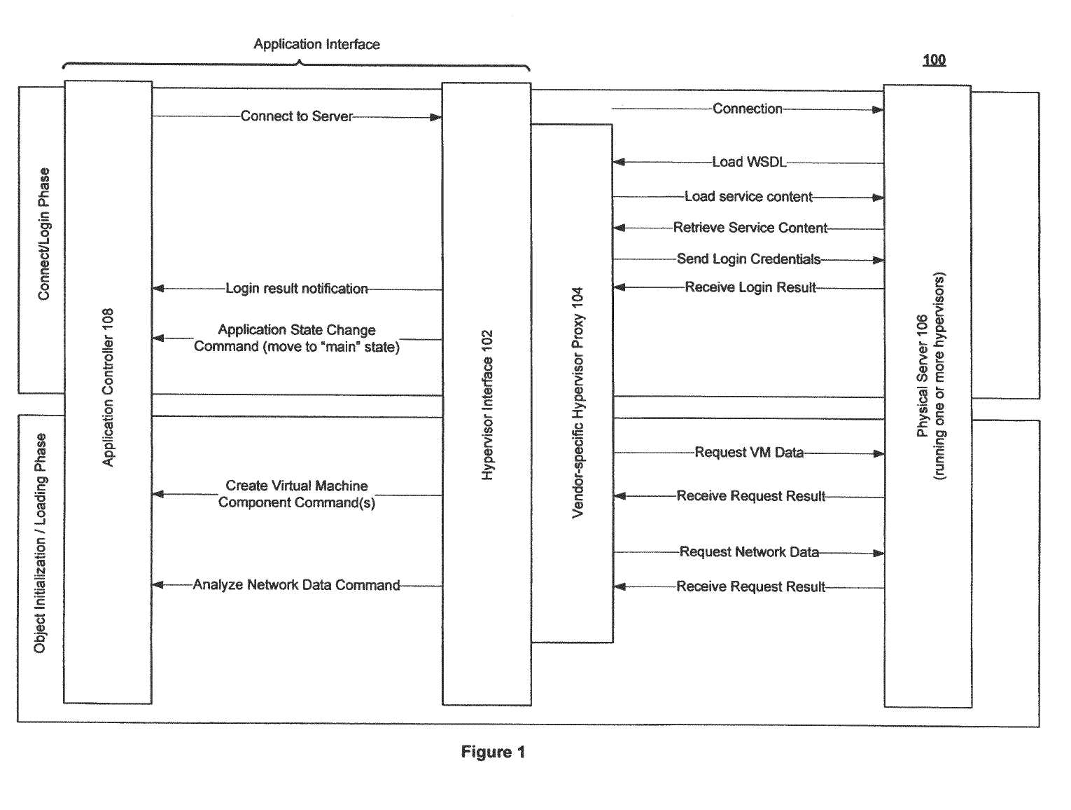

An exemplary embodiment of the present invention may provide a virtualization management framework. According to this embodiment, a management interface may be provided to interface with one or more hypervisors or virtual machine monitors. Referring to FIG. 1, an application interface for interfacing a virtualization management system with one or more hypervisors, in accordance with an exemplary embodiment is illustrated. As illustrated, virtualization management system 100 may contain application controller 108, hypervisor interface 102, vendor-specific hypervisor proxy 104, and physical server 106.

In some embodiments, application controller 108 may be a controller in an system implemented utilizing model-view-controller (MVC) architecture. It will be recognized by a person of ordinary skill in the art that the virtualization management framework may be implemented utilizing a client-server architecture, a database centric architecture, a three tier architectures or other software architectures.

In one or more model-view-controller based embodiments, application controller 108 may be implemented utilizing classes such as, for example, those listed in the com.bluebear.controller package in Appendix I of U.S. Patent Application No. 61/097,083. Application controller 108 may process and respond to events such as user interactions and data received from hypervisor interface 102.

Hypervisor interface 102 may utilize vendor-specific hypervisor proxy 104 to access physical server 106. Hypervisor interface 102 may be implemented utilizing classes, such as, for example, iHypervisor in the com.bluebear.interfaces package as detailed in Appendix II of U.S. Patent Application No. 61/097,083. Hypervisor interface 102 may be hypervisor agnostic and may simultaneously or sequentially interface with multiple hypervisors from disparate vendors. For example, hypervisor interface 102 may interface with hypervisors from VMWARE®, XEN®, MICROSOFT® and other vendors. Hypervisor interface 102 may provide access to management interfaces of such hypervisors and may access the native hypervisor functionality available through such interfaces. Hypervisor interface 102 may be utilized as an interface providing hypervisor management functionality for application controller 108.

Vendor-specific hypervisor proxy 104 may be an object providing access to a management interface of a hypervisor. For example, vendor-specific hypervisor proxy 104 may be a VMWARE® proxy. A virtualization management interface with a VMWARE® proxy may utilize a class such as VMWareServerProxy as described in Appendix 11 of U.S. Patent Application No. 61/097,083.

Physical server 106 may be a server running a hypervisor. Physical server 106 may be Intel based, Sparc based, or another physical computing platform.

As shown, a connection and/or login phase may begin with a connection to server request sent from application controller 108 to hypervisor 102. This may be in response to a user login request received by application controller 108. Hypervisor interface 102 may utilize vendor-specific hypervisor proxy 104 to access a hypervisor and establish a connection to physical server 106. The hypervisor may return web services description language (WSDL) to vendor-specific hypervisor proxy 104. Vendor-specific hypervisor proxy 104 may request the loading of service content. The hypervisor may return services content to vendor-specific hypervisor proxy 104. Vendor-specific hypervisor proxy 104 may then send login credentials to the hypervisor on physical server 106. The hypervisor may return a login result to vendor-specific hypervisor proxy 104. Vendor-specific hypervisor proxy 104 may provide the login result to hypervisor interface 102. Hypervisor interface 102 may send a login result notification to application controller 108. If the login is successful, hypervisor interface 102 may also send an application state change command to application controller 108 to move the virtualization management system to a main state.

At the beginning of the main state, an object initialization and loading phase may occur. Hypervisor interface 102 may request virtual machine (VM) data utilizing vendor-specific hypervisor proxy 104. Vendor-specific hypervisor proxy 104 may request virtual machine data from the hypervisor running on physical server 106. Vendor-specific hypervisor proxy 104 may receive the results and pass them to hypervisor interface 102. This may be an iterative process and hypervisor interface 102 may issue a virtual machine creation command to application controller 108 for each set of virtual machine data received. For example, if fifty virtual machines are managed by a hypervisor running on physical server 108, fifty sets of virtual machine data may be requested and received by hypervisor interface 102. Hypervisor interface 102 may issue fifty create virtual machine commands to application controller 108.

Hypervisor interface 102 may also utilize vendor-specific hypervisor proxy 104 to request virtual network data from one or more hypervisors. Network data may include data describing available networks and/or domains on one or more hypervisors.

Virtualization management system 100 may provide an open application programming interface (API) allowing for the integration of additional technology.

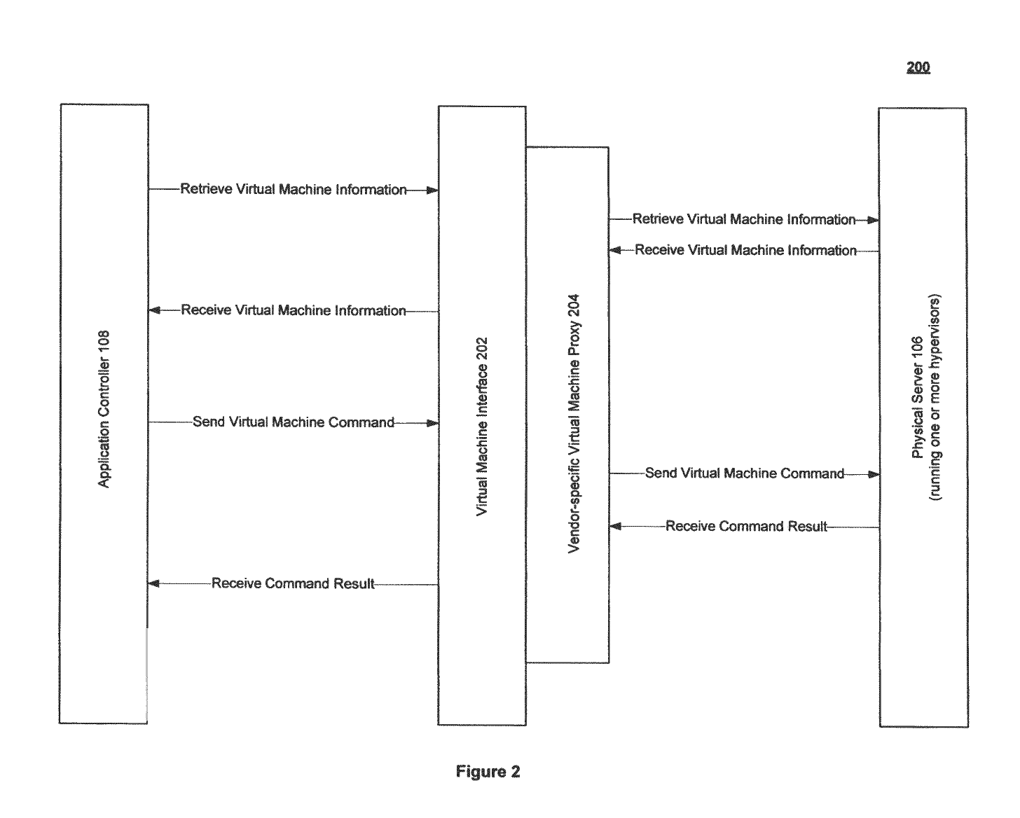

FIG. 2 depicts an application interface for interfacing a virtualization management system with one or more hypervisors, in accordance with an exemplary embodiment. As illustrated, virtualization management interface 200 may contain application controller 108, virtual machine interface 202, vendor-specific hypervisor proxy 204, and physical server 108.

Virtual machine interface 202 may utilize vendor-specific virtual machine proxy 204 to access physical server 106. Virtual machine interface 202 may be implemented utilizing classes, such as, for example, VMWareVirtualMachineProxy in the com.bluebear.model.VMWARE package as detailed in Appendix II of U.S. Patent Application No. 61/097,083. Virtual machine interface 202 may be hypervisor agnostic and may interface with multiple hypervisors from disparate vendors. For example, virtual machine interface 202 may interface with hypervisors from VMWARE®, XEN®, MICROSOFT® and other vendors. Virtual machine interface 202 may provide access to management interfaces of such hypervisors and may access the native hypervisor functionality available through such interfaces. Virtual machine interface 202 may be utilized as an interface providing virtual machine management functionality for application controller 108.

Vendor-specific hypervisor proxy 204 may be an object providing access to a management interface of a hypervisor. For example, vendor-specific hypervisor proxy 204 may be a VMWARE® proxy and a virtualization management framework may interface with the VMWARE® proxy utilizing a class such as VMWareServerProxy as described in Appendix II U.S. Patent Application No. 61/097,083.

As shown, application controller 108 may access virtual machine functionality via virtual machine interface 202. Application controller 108 may send a request to retrieve virtual machine information to virtual machine interface 202. Virtual machine interface 202 may utilize vendor-specific virtual machine proxy 204 to retrieve virtual machine information from a hypervisor running on physical server 106. Application controller 108 may also execute one or more commands to manage a virtual machine using virtual machine interface 202. For example, in an embodiment utilizing the iVirtualMachine class, application controller 108 may utilize public methods to power on a virtual machine, power off a virtual machine, reboot a virtual machine, reset a virtual machine, retrieve statistics from a virtual machine, and other actions.

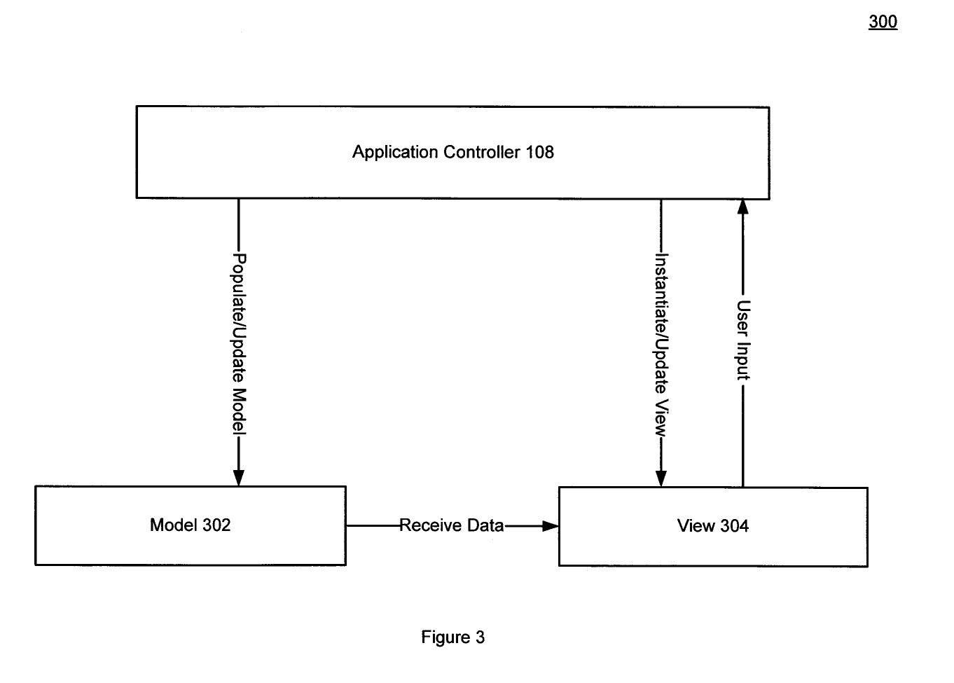

FIG. 3 depicts an architecture for providing a user interface, business logic and business rules for a virtualization management system, in accordance with an exemplary embodiment. As shown, model-view-controller architecture 300 may contain application controller 108, model 302, and view 304.

Model 302 may be utilized to store arrays of data, such as data associated with hypervisors and virtual machines. In some embodiments, model 302 may utilize one or more classes described in Appendix II U.S. Patent Application No. 61/097,083, such as, for example, HypervisorListProxy class, HypervisorProxy class, HypervisorProxyFactory, and/or VirtualMachineProxy. Model 302 may populated and updated by application controller 108.

View 304 may provide a user interface for a virtualization management system. In some embodiments, view 304 may utilize one or more classes described in Appendix II of U.S. Patent Application No. 61/097,083, such as, for example, ApplicationMediator, HypervisorListMediator, and/or HypervisorMediator. View 304 may be a user interface implemented in a cross platform runtime environment, such as, for example, Adobe Integrated Runtime (AIR). This may enable a virtualization management system to be deployed as a desktop application to a variety of platforms. A runtime environment may decouple many security aspects of the virtualization management system from the desktop. View 304 may be instantiated and/or updated by application controller 108. View 304 may accept user input and provide it to application controller 108. View 304 may receive data from model 302. For example, view 304 may receive data regarding hypervisors, networks and/or virtual machines to display from model 302.

In one or more embodiments, a virtualization management system may provide alerting functionality. The alerting functionality may provide pop-up windows, indicators or other notifications of one or more events. The notifications may be presented when a criteria has met or exceeded a specified threshold. For example, a user may request a notification when one or more virtual resources has exceeded a specified memory or CPU utilization threshold. Notifications may vary according to a threshold level which may provide an indication of status and/or severity of a condition. For example, warning notifications may be provided when a particular parameter enters within a user specified range. Error notifications may be provided when such a parameter exceeds that user specified range. Notifications may also occur based on events such as a hung virtual machine and/or a security violation (e.g., a user attempts to gain root access to a console).

In some embodiments, a virtualization management system may provide options to a user in response to one or more notifications or alerts. For example, a user may be prompted to reboot a hung virtual machine. A user may also be prompted to migrate a virtual machine to a separate physical computing platform if the CPU and/or memory utilization of one or more virtual machines is exceeding a certain threshold. In one or more embodiments, virtual machine migration may utilize native virtual machine migration capabilities of a hypervisor. A virtualization management system may be configured by a user to perform certain actions automatically if a notification meets specified criteria. For example, a user may specify that a virtualization management system may automatically reboot one or more virtual machines if it detects that the one or more virtual machines are hung.

A virtualization management system may provide credential and/or password management. For example, an administrator may log into the virtualization management system and may not be required to log into a hypervisor, a virtual machine and/or a virtual resource. The virtualization management system may store one or more encrypted passwords of a user and may associate the passwords with the credentials of the user. This may simplify the administration of multiple resources in a secure manner.

An exemplary embodiment may provide a unified interface allowing for the management of multiple virtualization platforms. According to this embodiment, a unified interface may provide a flexible, intuitive, Graphical User Interface (GUI). The GUI may provide multiple views of one or more virtualization platforms.

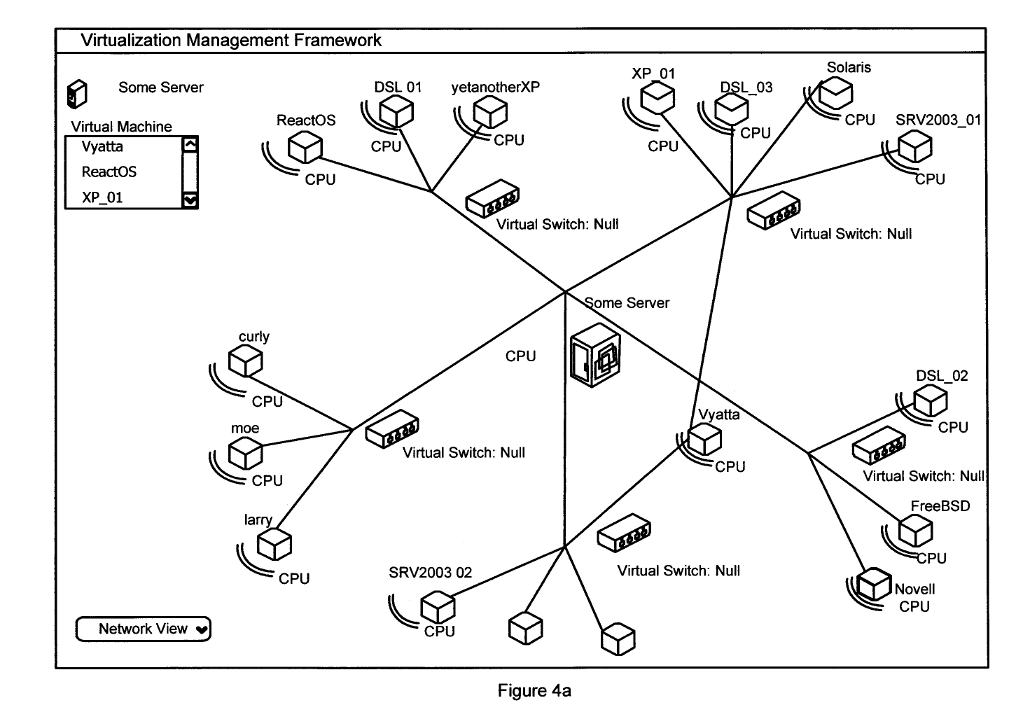

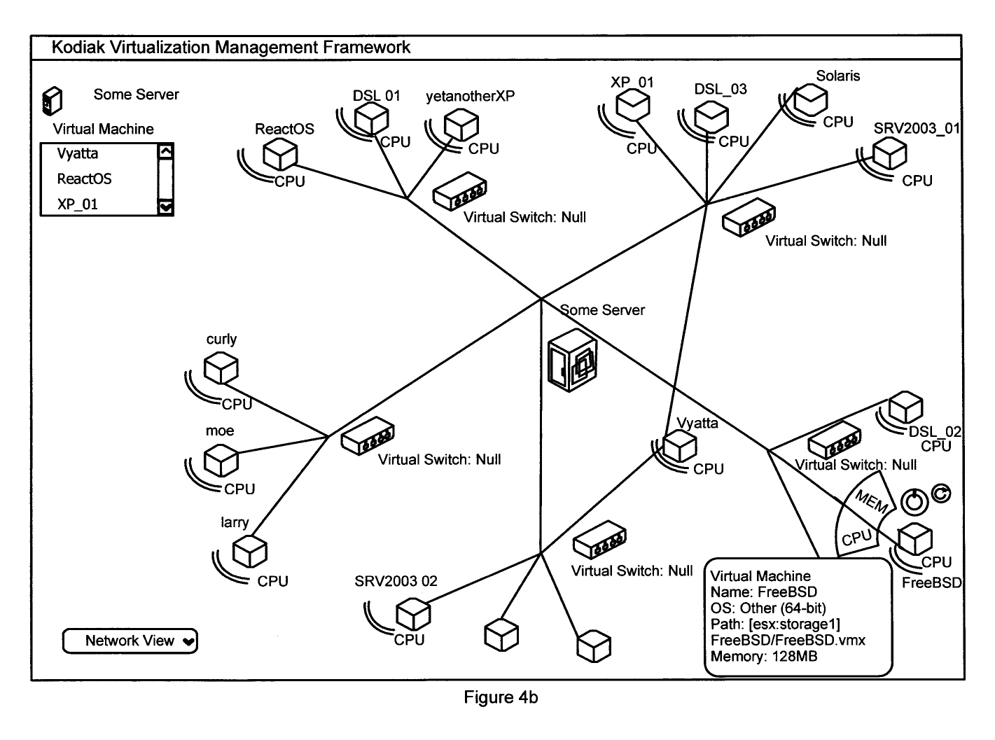

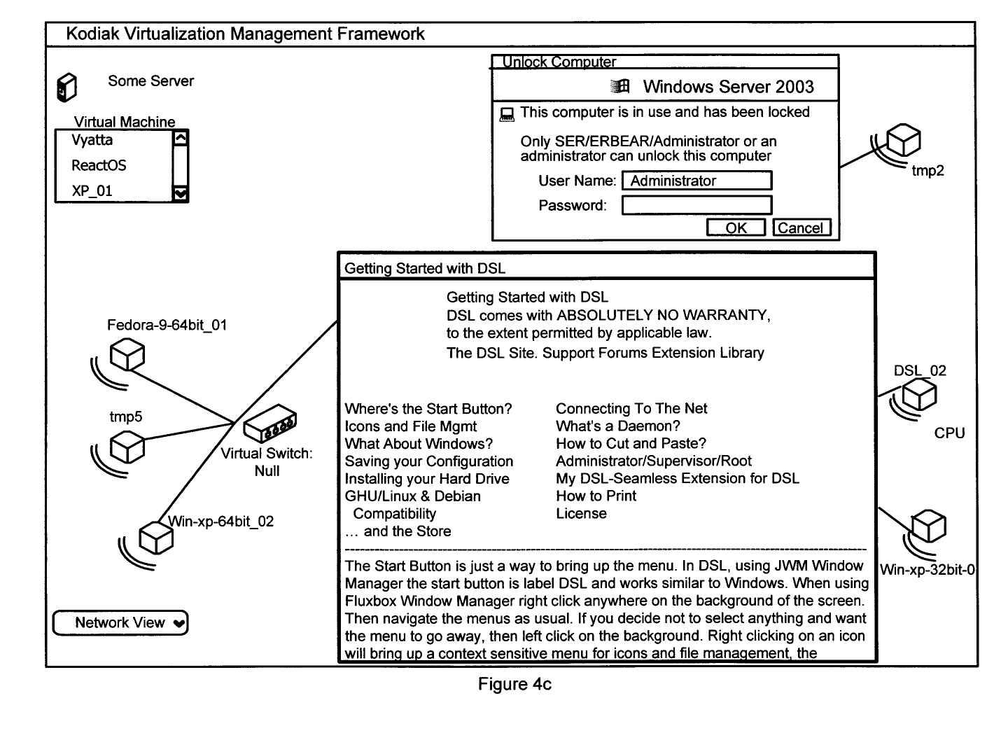

FIG. 4a depicts a user interface for a virtualization management system, in accordance with an exemplary embodiment. As depicted, a virtualization management system may provide a network topology based interface which may display one or more virtual infrastructures in an interactive, intuitive manner. In one embodiment, a network topology may be structured with an icon representing a Hypervisor, such as the one labeled “some server,” at the center of a displayed virtual network infrastructure. The interface may display multiple hypervisors and related virtual infrastructures. A hypervisor icon may be connected by a line or other indicator showing network connectivity to one or more virtual switch icons. A virtual switch icon may be connected to one or more virtual machine icons.

Virtual machine icons may utilize logos to indicate an associated operating system, or other information. Virtual machine icons may also contain labels indicating an associated host name, a network address or other information. Virtual machine icons may utilize colors to indicate a current status or other events. For example a red shadow or highlight may indicate a critical condition, a yellow indicator may signify a warning, a green indicator may signify a normal operating status, a grey indicator may signify a powered off or otherwise unavailable status. Other indicators and statuses may be utilized. For example, as illustrated, a virtual machine icon may contain a plurality of semi-circular arcs providing status information, such as a green arc indicating a level of memory utilization and a red arc indicating a level of CPU utilization. Indicators may reflect a current status of a virtual machine. In some embodiments, hypervisor icons and/or virtual switch icons may provide one or more indicators to provide their status. The colors, logos, shapes, layout and other aspects of the icons in the user interface may be controlled by one or more user settable preferences.

Icons and other objects in the user interface may allow a user to utilize drag and drop to change the positioning of the icons. In some embodiments, dragging a virtual machine icon over or close to a virtual switch may notify a user with a prompt regarding network connectivity of the virtual machine. The interface may prompt the user with the option of adding a new network connection from the virtual machine to the virtual switch. The interface may also prompt the user with the option of migrating one or more existing network connections of the virtual machine from other virtual switches to the current virtual switch. In some embodiments, network connectivity may be manipulated by dragging or dropping lines indicating network connectivity. For example, dragging or dropping a network indicator line to or from a virtual machine may add or delete that network connection from the virtual machine. Similarly, dragging or dropping a network indicator line to or from a virtual switch may add or delete that network connection from the virtual switch. Network connections may be removed by highlighting or otherwise setting focus on a network indicator line and deleting the line. Network connectivity may also be manipulated by opening a console window to a virtual machine and adjusting the network configuration for that virtual machine.

The user interface may contain multiple portions. As illustrated in FIG. 4a, a list box or other user control may be provided displaying a list of virtual infrastructure resources. Although FIG. 4a illustrates the user control in the upper left portion of the screen, it may be dragged to other locations on the screen and may float on the screen. It may also be provided with one or more handles for resizing. The list of virtual infrastructure resources may be grouped underneath the associated hypervisor, grouped by resource type (e.g., virtual machines together, virtual switches together, etc.), may be arranged alphabetically, arranged with the most recently used resources listed first, and/or arranged by utilization of a virtual machine. The list of virtual infrastructure resources may enable a user to double click on a resource, right mouse click on a resource or otherwise interact with a user control to perform one or more actions. For example, right mouse clicking a virtual machine may provide menu choices to power off the virtual machine, power on the virtual machine, reboot a virtual machine, open a console window for a virtual machine and/or other actions.

The user interface may contain a toggle button such as the one illustrated in the lower left of FIG. 4a, which may enable a user to switch the interface view. For example, the view illustrated may be a network view displaying virtual resources by network connectivity and in relation to their respective hypervisor. Another view may display only virtual machines without network connectivity, virtual switches, and/or hypervisors. Yet another view may display only open consoles for virtual machines. Views may be utilized to filter, such as displaying only the virtual resources associated with a particular hypervisor, the virtual resources associated with a particular virtual switch, or by other criteria.

FIG. 4b depicts a user interface for a virtualization management system, in accordance with an exemplary embodiment. Highlighting or mousing over an icon may provide more detailed information and may enable further user controls. As illustrated, the icon labeled “FreeBSD”, representing a virtual machine running FreeBSD, currently has focus. A tool tip window may display further information such as virtual resource type, virtual resource name, an operating system associated with the virtual resource, a path for one or more configuration files associated with the virtual resource, memory statistics associated with the virtual resource and other information. More detailed indicators may be displayed around a virtual resource which current has focus, such as, an enlarged CPU utilization status indicator, an enlarged memory status indicator, and/or other indicators. Additional user controls for a virtual resource may be displayed when the virtual resource has focus or upon mouse-over of the virtual resource. For example, a power toggle button for a virtual machine, a reset button for a virtual machine, and/or a console button for a virtual machine. Additional controls and more detailed indicators may also be displayed for a virtual resource in response to other user actions such as right mouse clicking on an icon, and/or double clicking an icon. Thus a user may be able to navigate one or more virtual infrastructures in a logical manner and may drill down to obtain more information and more control of a specific virtual resource.

FIG. 4c depicts a user interface for a virtualization management system, in accordance with an exemplary embodiment. As illustrated in FIG. 4c, multiple console windows may be open concurrently. In some embodiments, the number of console windows open may be limited only by resources of a platform running the virtualization management system. Console windows may be stacked, tiled, and or resized. Console windows may be manipulated using drag and drop and may be freely detached from a main application window.

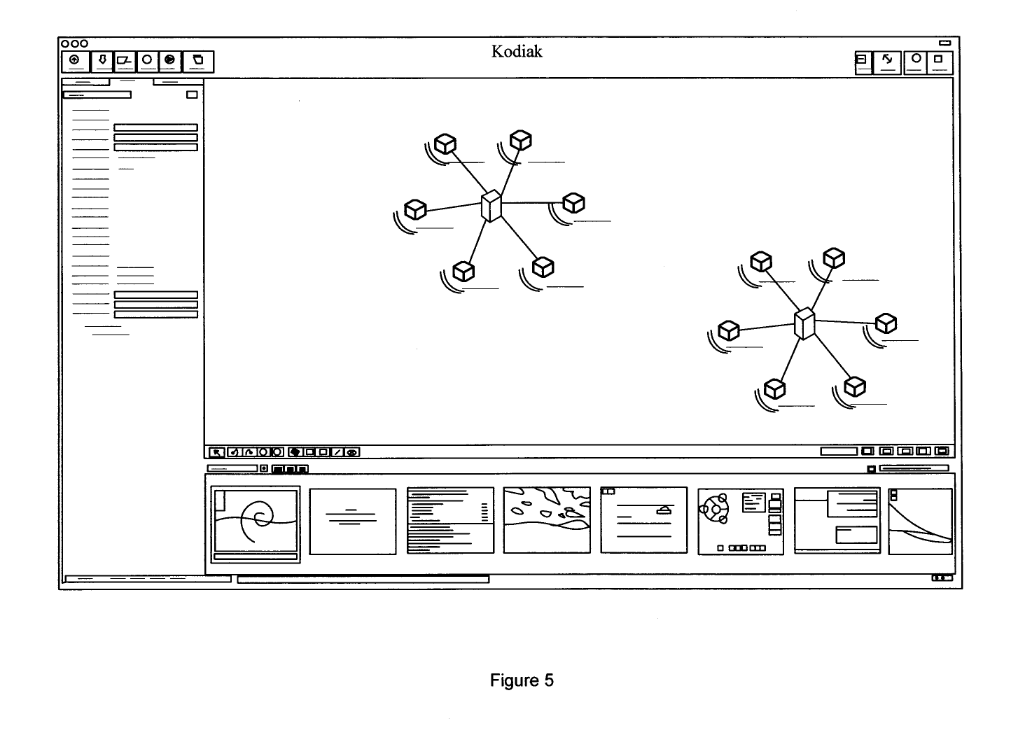

FIG. 5 depicts a user interface for a virtualization management system, in accordance with an exemplary embodiment. As illustrated, the user interface may contain a network topology for two separate hypervisors. In some embodiments, more than two hypervisors may be included. The two separate hypervisors may be running on separate physical servers and may be implemented using different hypervisor software (e.g., VMWARE®, XEN®, MICROSOFT®, etc.). The user interface may contain separate portions, frames, and/or panels. For example, a portion of the interface may contain a displayed network topology. A second portion may contain one or more open console windows associated with one or more virtual resources. A third window may contain detailed information about one or more virtual resources.

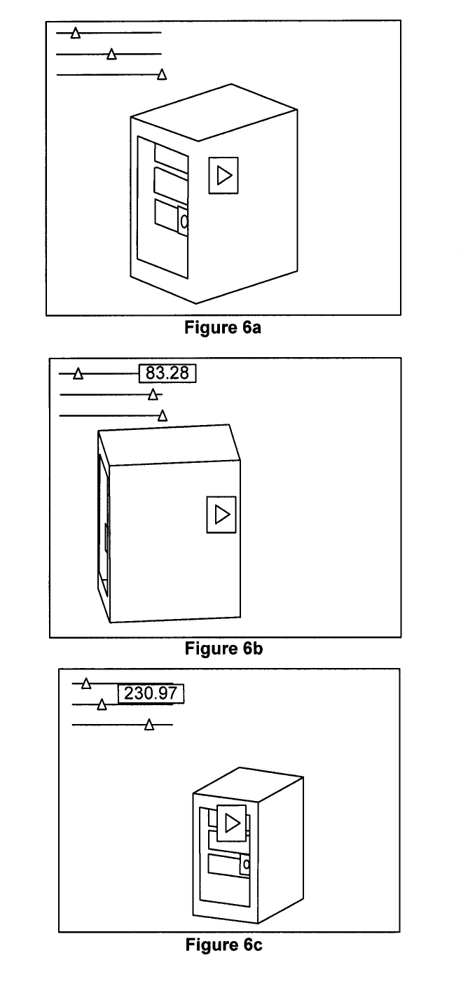

FIGS. 6a, 6b and 6c depict a portion of a user interface for a virtualization management system, in accordance with an exemplary embodiment. FIGS. 6a, 6b, and 6c illustrate an ability of a user to manipulate the positioning of a virtual resource icon in the user interface. Upon focus or other user action indicating selection of a particular virtual resource icon, a user may be provided with controls allowing a user to tilt, pan and/or zoom a virtual resource icon. For example, a first slider control may control the tilt of a virtual resource icon, a second slider control may control panning of the virtual resource icon, and a third slider control may control zooming of the virtual resource icon. As shown in FIG. 6b, the panning of the virtual resource icon was adjusted from the relative position illustrated in FIG. 6a. As shown in FIG. 6c the panning and the zoom level of the virtual resource icon was adjusted from the relative position in FIG. 6a.

Manipulation of a virtual resource icon may enable a user to navigate more intuitively. For example, a user may be able to pan a virtual resource icon to view a network port or other aspect of a virtual resource on a side of the virtual resource icon. This may enable interaction with the virtual resource such as selecting a port for a network connection on a virtual resource.

In various exemplary embodiments, a hardware platform for virtualization may also be provided. Current virtualization technology may typically be shackled to a large data center. The hardware platform described herein, however, may be a physically small, yet powerful and flexible, virtualization-ready server. Because of its size and power, the hardware platform may allow the benefits of virtualization from any location (e.g., where it is not cost effective to have a large rack of servers). The platform may be adaptive, resilient, and scalable. It may integrate networking functionality and may support a plurality of hypervisors. The platform may have a natural-convection cooled, fan-less chassis for thermal optimization. The chassis may be designed to be particular rugged for mobile implementations and may be adapted to handle a wide range of temperatures and air flows, as described herein. Circuits may be placed to avoid possible interference among tightly placed components, to improve performance, and/or to reduce power consumption. Although the exemplary embodiments described herein may be described in reference to virtualization, it will be recognized by one skilled in the art that the hardware platform may be used in any way for any purpose.

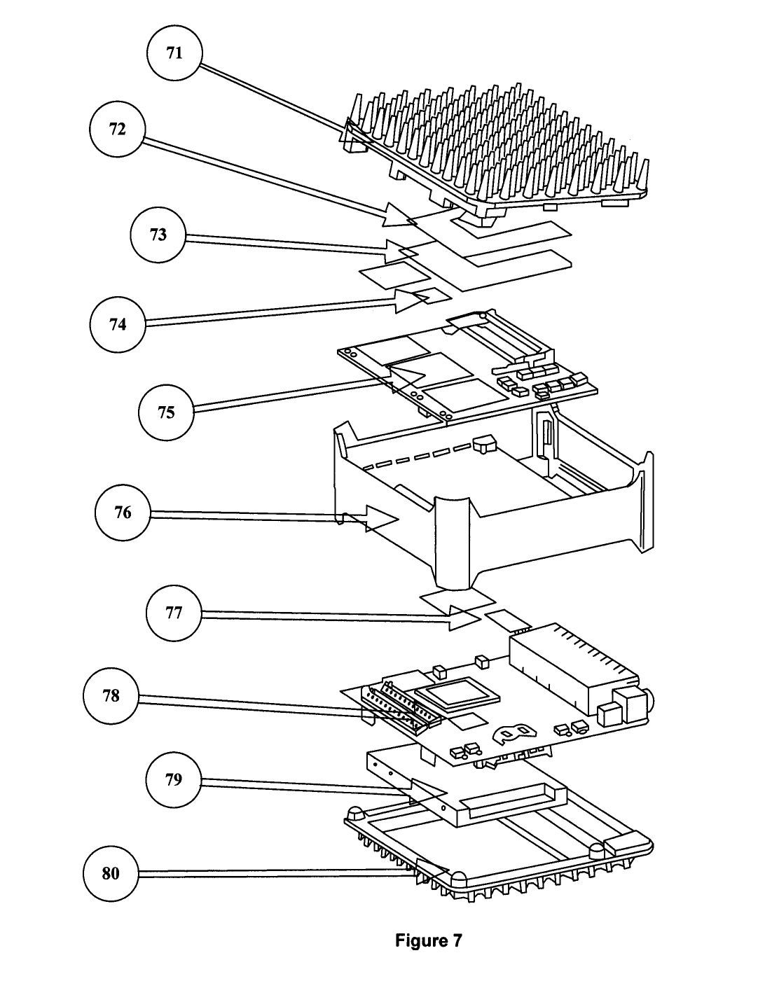

FIG. 7 depicts an exemplary embodiment of a hardware platform for virtualization. The device depicted in FIG. 7 may comprise various components designed to optimize heat distribution. Top chassis 71 may be a heatsink designed to conduct thermal energy away from the platform's components that generate the most heat and may comprise, for example, 80% or more of the platform's cooling capacity. Composite solder 72 may be a titanium/magnesium alloy with minimal thermal impedance and superior conductivity. Composite solder 72 may be designed to move heat away from the central processing unit (CPU) because of its combination with copper and/or aluminum component parts. In one or more embodiments, thermal gap filler may be used in place of composite solder 72. Copper spreader 73, for example, may also be designed to provide conductivity while also having an exemplary low weight and low price. Phase-change thermal interface 74 may be placed between the CPU of COM Express module 75 and copper spreader 73 to move heat away from the CPU. Pressure may be applied via spring washers and/or other components for optimal cooling performance. COM Express module 75 may be an integrated CPU module that plugs into a customized carrier board 78, as described herein. It will be recognized by those skilled in the art that COM Express modules may typically be used to alleviate the need for designing and building a full custom motherboard and may be upgradeable as technology evolves. Other types of modules may be provided as well. Mid-chassis 76 may be a heatsink that provides structure for the platform and regulates internal ambient temperature with side vents designed to aid in air circulation and minimize pools of unmoving air. Thermal gap filler 77 may be positioned between chips on carrier board 78 and mid-chassis 76 to provide conformability between SMT (Surface Mount Technology) devices of differing heights. Carrier board 78 may be a customized carrier board for providing a virtual environment, as described herein. Hard disk drive 79 may in various exemplary embodiments be a 2.5 inch laptop size hard-disk or solid-state drive on an SATA (Serial ATA) 3 Gbps bus. Hard disk drive 79 may be optional. Bottom chassis 80 may be a heatsink that performs cooling, especially when equipped with hard disk drive 79. Bottom chassis 80 may also correct the platform's center of gravity, which may be thrown off by copper spreader 73.

In various exemplary embodiments, a hardware platform for virtualization may comprise on or more of the following components:

(1) COM Express Carrier Board to mate with a Kontron® ETXexpress-MC COM Module. The Board may support the COM Express Basic form factor and have dimensions of 125 mm×125 mm;

(2) A Broadcom BCM5398 8-port Gigabit Ethernet switch IC, with seven ports connected to ganged external RJ-45 ports, and one port connected to the COM Express integrated Ethernet port.

(3) Two Intel 82571 dual-port Gigabit Ethernet controllers. One may be attached to the x4 PCIe port from the Com Express board, and the other may be attached to the x16 PCIe Graphics port (only x4 PCIe lanes will be used). All four ports may be connected to the ganged RJ-45 connector. In various exemplary embodiments, network controllers, such as the Intel 82571 dual-port Gigabit Ethernet controllers described herein, may be loaded with a memory or otherwise access a storage mechanism to allow the hardware platform to be loaded over a network. Network controllers may utilize iSCSI (Internet Small Computer Systems Interface) to access SCSI targets on remote computers. In that case, the network-bootable hardware platform may not need a hard disk drive, such as the 2.5″ SATA disk drive described herein, and may therefore be more flexible than a hardware platform with a hard disk drive.

(4) A Tyco 1368034-1 12 port (2×6) ganged RJ-45 connector and the discrete magnetics modules for all Gigabit Ethernet ports.

(5) A RJ-45 port for RS-232 serial communications, and one (1) internal header for RS-232 serial communications, both connected to a Winbond 83627HF Super I/O IC.

(6) An external USB port.

(7) A 2.5 inch SATA disk drive, mounted to the PCB.

(8) Two (2) Gigabytes of NAND flash connected through either USB or the PATA interface on the COM Module.

(9) An internal VGA header.

(10) 12V DC Power input.

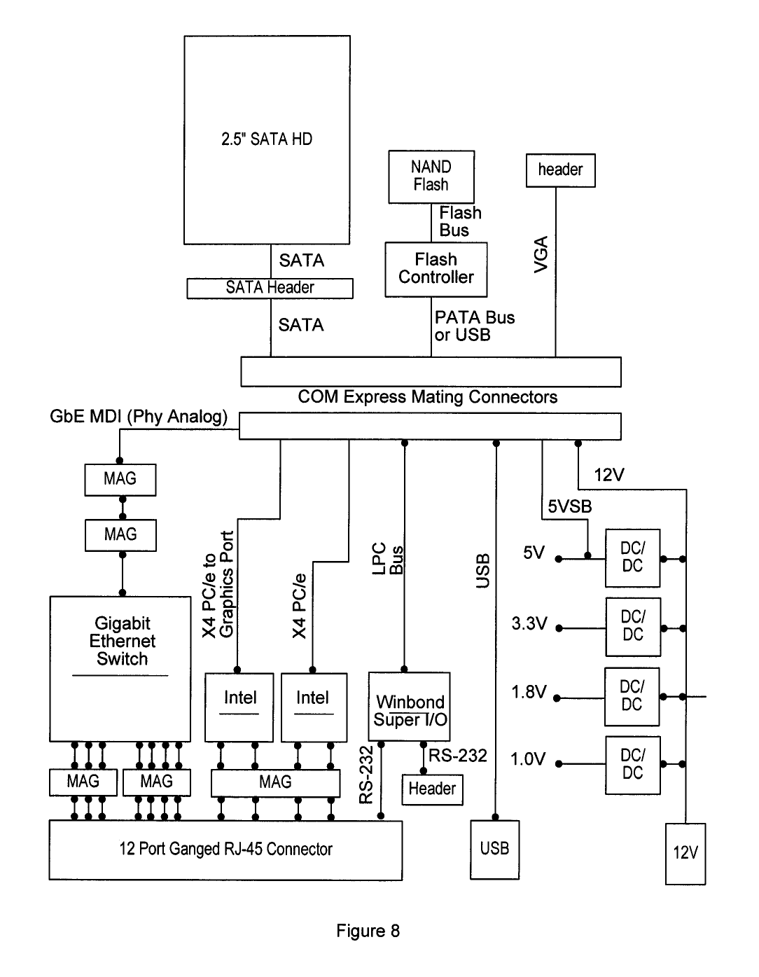

FIG. 8 depicts an exemplary architecture for a COM Express Carrier Board as described above. The COM Express Carrier Board may, for example, match the COM Express “Basic” form factor of 95×125 mm with connectors in the appropriate positions to mate with the COM Express Pinout Type-2 compliant Kontron ETXexpress-MC COM Module. The COM Express mating connectors may be chosen to maintain a standard 5 mm spacing between the Module and Carrier. For example and without limitation, the platform may also comprise one or more of the following components and/or features:

(1) A Broadcom BCM5398 8 port Gigabit Ethernet switch with 7 ports connected to external ganged RJ-45 connectors using appropriate magnetics. The one remaining port may be connected to the COM Express board integrated Ethernet Port using dual magnetics, or some sort of magnetic coupler.

(2) Four 1000Base-T Gigabit Ethernet ports implemented using two Intel 82571 MAC/Phy ICs, and attached to the ganged RJ-45 connector using appropriate magnetics, and any additional components. One dual MAC/Phy may integrate with the COM Express board using the available x4 PCIe lanes. The other may integrate using four lanes of the x16 PCIe Graphics Attach Port.

(3) A Tyco 1368034-1 12 port (2×6) ganged RJ-45 connector. This connector may support four Gigabit Ethernet ports from the two dual MAC/Phy ICs, seven Gigabit Ethernet ports from the Broadcom switch IC, and one RS-232 port.

(4) The device may implement one RS-232 serial port as an external connector, and one RS-232 serial port as an internal header. Both serial ports may be supported by a Winbond 83627HF Super I/O IC, connected to the COM Module through the LPC bus. The external RS-232 port may be connected to one port of the ganged RJ-45 Connector.

(5) An external USB port using a vertically-oriented USB connector.

(6) The carrier board may allow for a 2.5″ SATA disk to be mounted directly, or indirectly, to the PCB. There may be some amount of stand-off between the bottom of the drive and the PCB to allow components to be populated under the drive. The design may incorporate a header connector to allow direct connection of the drive (i.e., no cables). In various exemplary embodiments, the stand-off may be as little as 1 mm, or as much as 5 mm.

(7) The device may implement 2 Gigabytes of NAND flash accessible over either the PATA bus or a USB port available through the COM Express mating connectors.

(8) The device may implement a VGA header that may be internally accessible only.

(9) The COM Express carrier may be supplied with 12V DC through a non-specified connector. From this supply the carrier may power its own circuitry, and pass power through to the COM Express module through the module mating connectors. The carrier may supply both 12V DC (as passed into the carrier) and 5V for standby operations. The specification for the 12V input may be defined by the module as regulated 12V±5%.

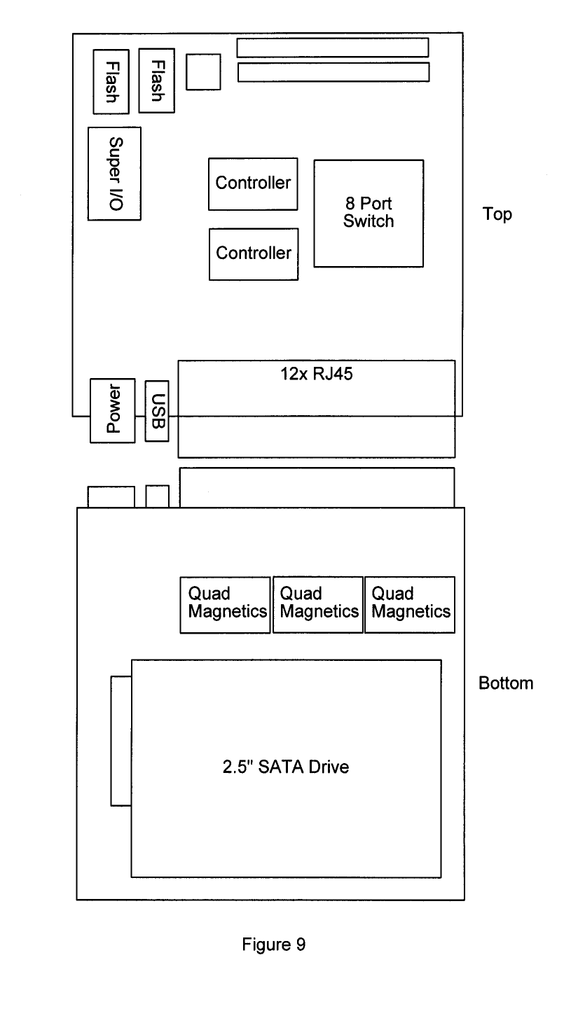

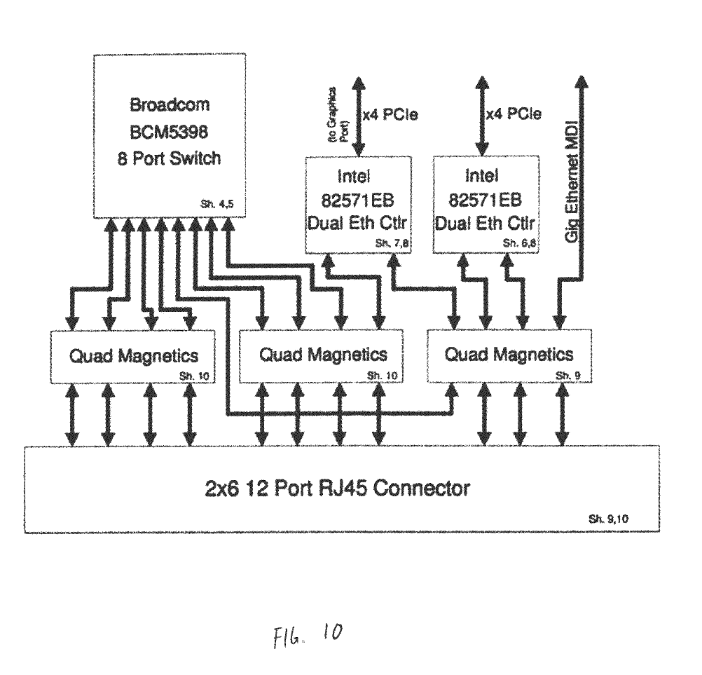

FIG. 9 depicts exemplary connection locations for the platform described above. As depicted in FIG. 9, in various exemplary embodiments, the Ethernet RJ-45s, the USB port, and the 12V input power connector may all be placed on one edge of the board. The 2.5″ SATA disk drive may be mounted in the middle of the bottom of the board.

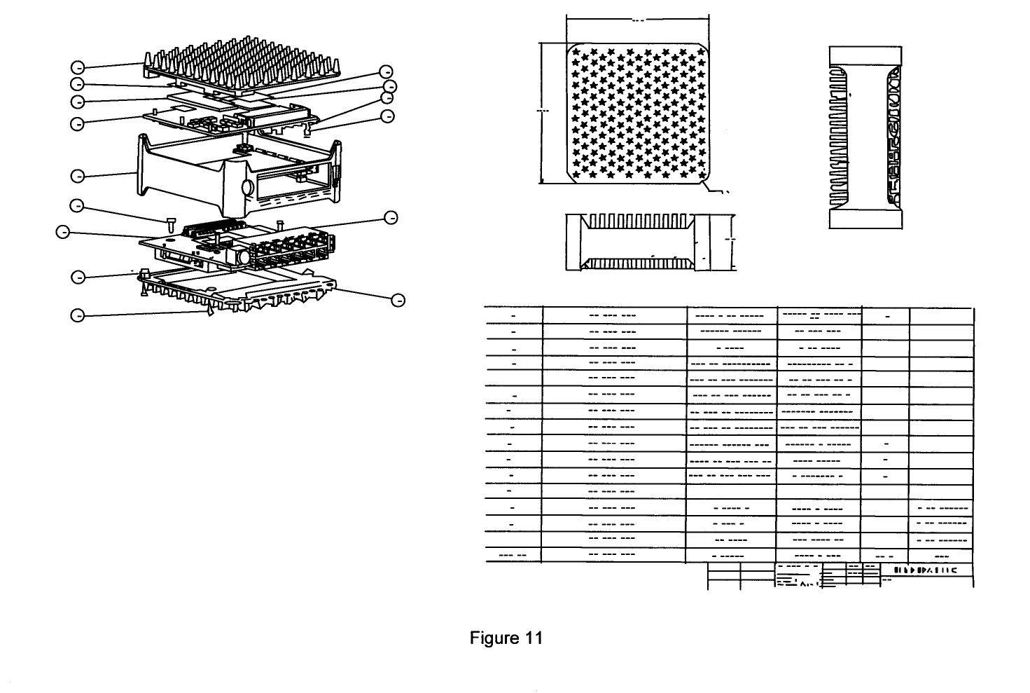

FIG. 10 depicts an exemplary circuit diagram of a carrier board, as described herein. The carrier board may provide robust networking functionality and may, for example and without limitation, comprise one or more of the following components: 5×1000 Mbps (gigabit) network interface controllers (NIC); 2x Intel 82571; 1x Intel 82566; and a Broadcom BCM5398 8 port switch, which may be internally linked to one of the NICs, as depicted in FIG. 10. Each NIC may allow the platform to service one physically independent subnet (for a total of 5). The NICS may be further divided by the hypervisor into up to 4000 “port groups” or VLANs. All controllers may be guaranteed performance due to the circuit arrangement depicted in FIG. 10.

In one illustrative example, a 1000 mb/s (megabit per second) NIC may equate to approximately 125 MB/s (megabytes per second) of data throughput. The 1x PCIe lane may also be capable of that same 125 MB/s (half-duplex operation) so to ensure maximum bandwidth to the controllers. Excess bus capacity may be desirable. Therefore, the 4x links to the 82571 chips may be provided. COM Express modules may typically be based on notebook chipsets, which may be much less equipped than their server counterparts when it come to PCI lanes. The platform described herein may reliably demux SVDO signaling from the PCI graphics lanes, freeing up 4x additional lanes.

The platform described herein may also comprise an on-board NAND flash (e.g., 16 gigabytes), which may be used to house and boot hypervisor software. Doing so may allow physical separation of the hypervisor (on flash) and virtual machines (on disk), which may be more secure. Doing so may also eliminate storage bus contention because both the host and its virtual machines get their own.

FIG. 11 depicts an exploded view of a hardware platform for virtualization.

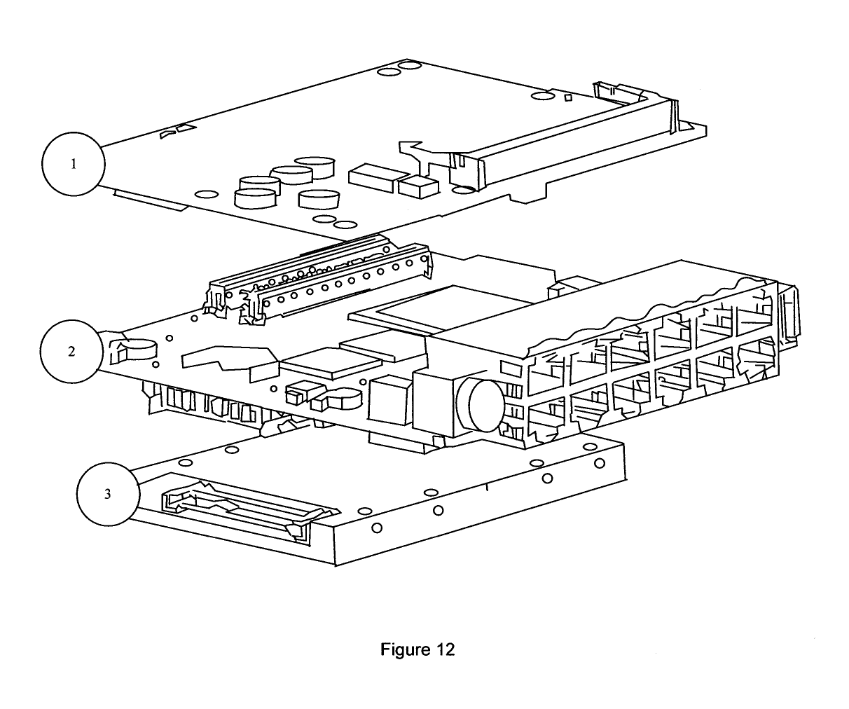

FIG. 12 depicts an exploded view of three components of a hardware platform for virtualization: a COM Express module I, a carrier board 2, and a hard disk drive 3.

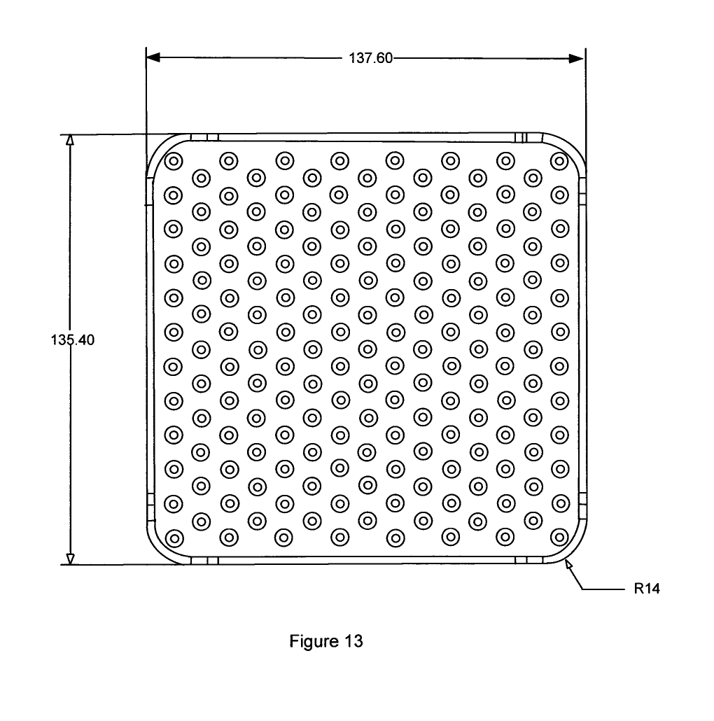

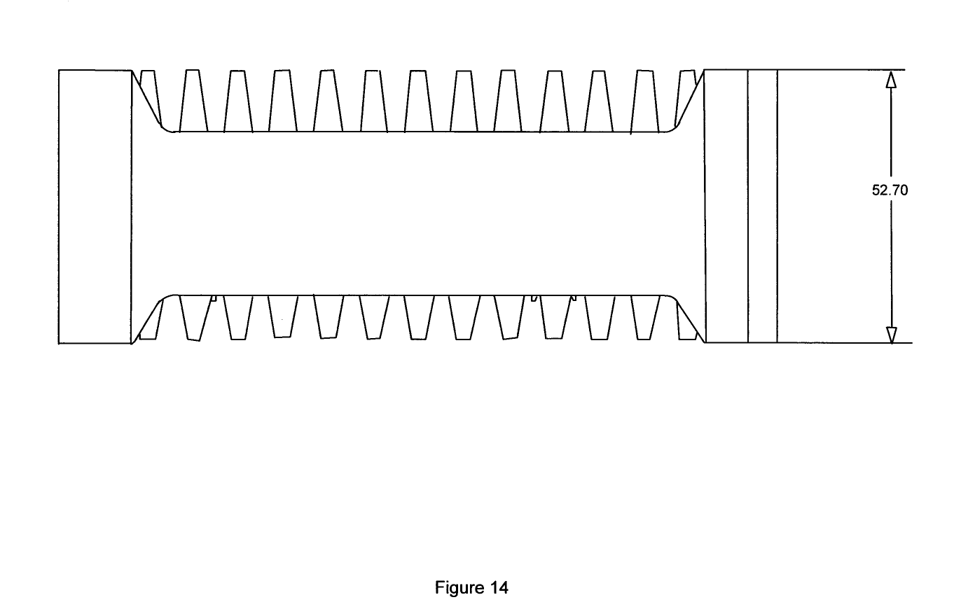

FIG. 13 depicts an exemplary top view of a hardware platform for virtualization.

FIG. 14 depicts an exemplary side view of a hardware platform for virtualization.

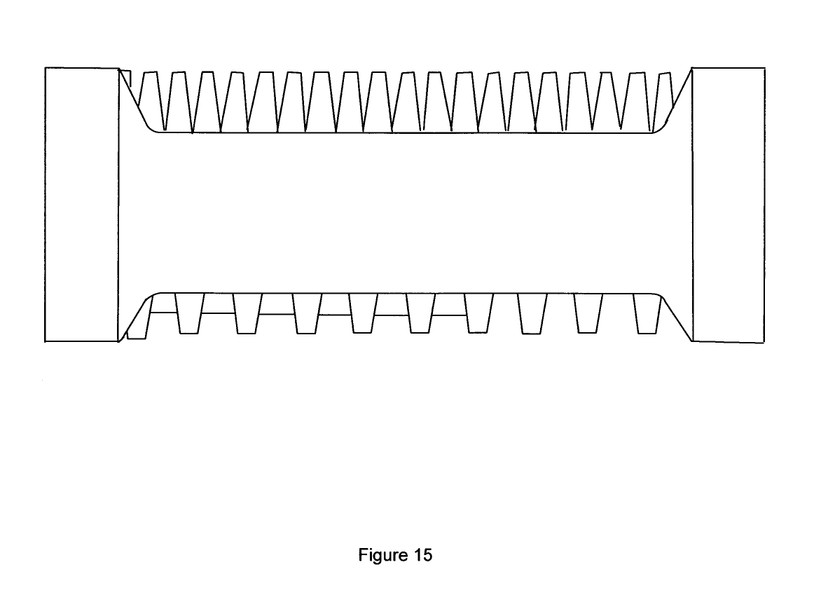

FIG. 15 depicts an exemplary top view of a hardware platform for virtualization.

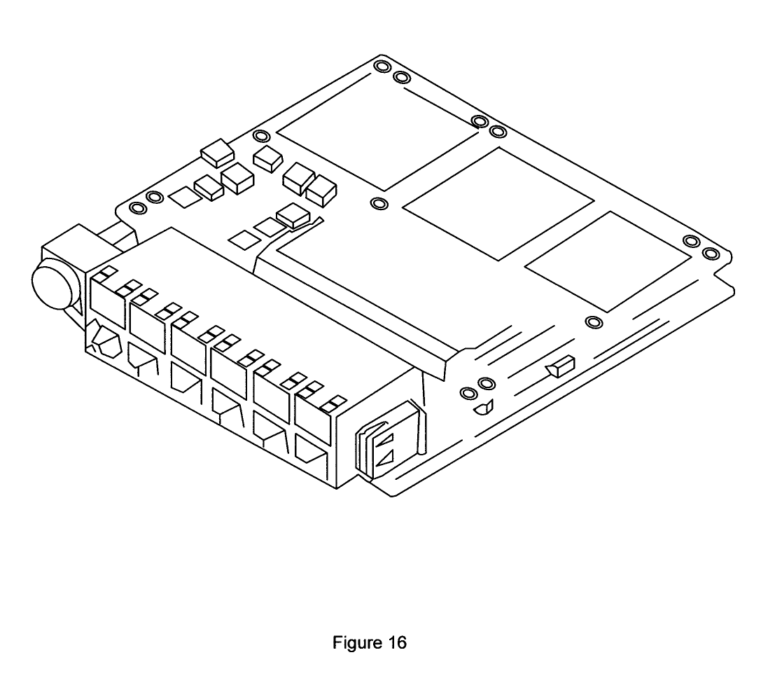

FIG. 16 depicts an exemplary top-front view of a carrier board for a hardware platform for virtualization.

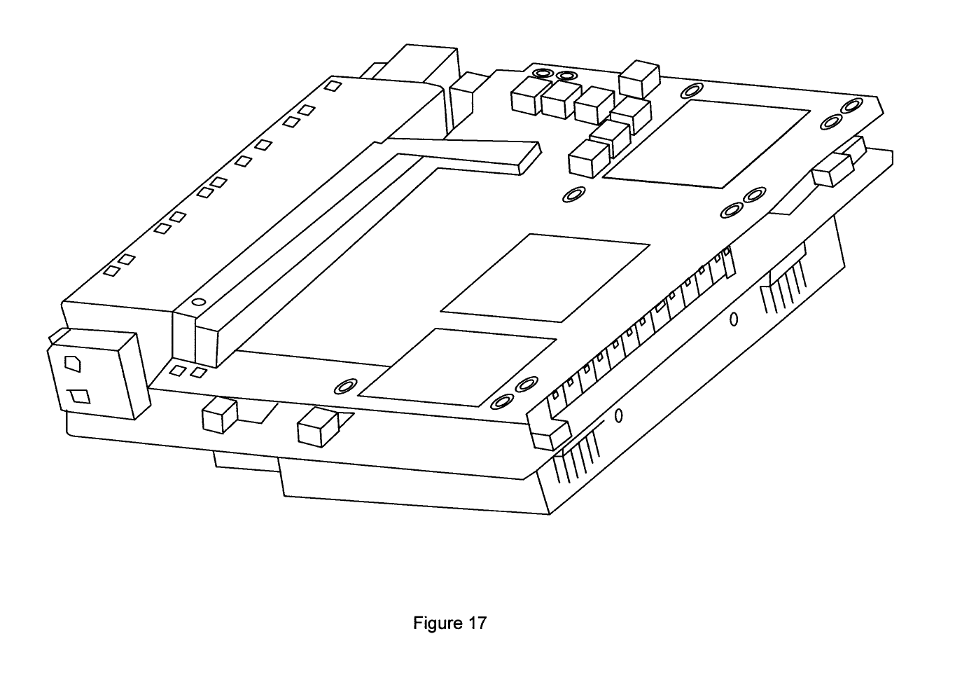

FIG. 17 depicts an exemplary top-rear view of a carrier board for a hardware platform for virtualization.

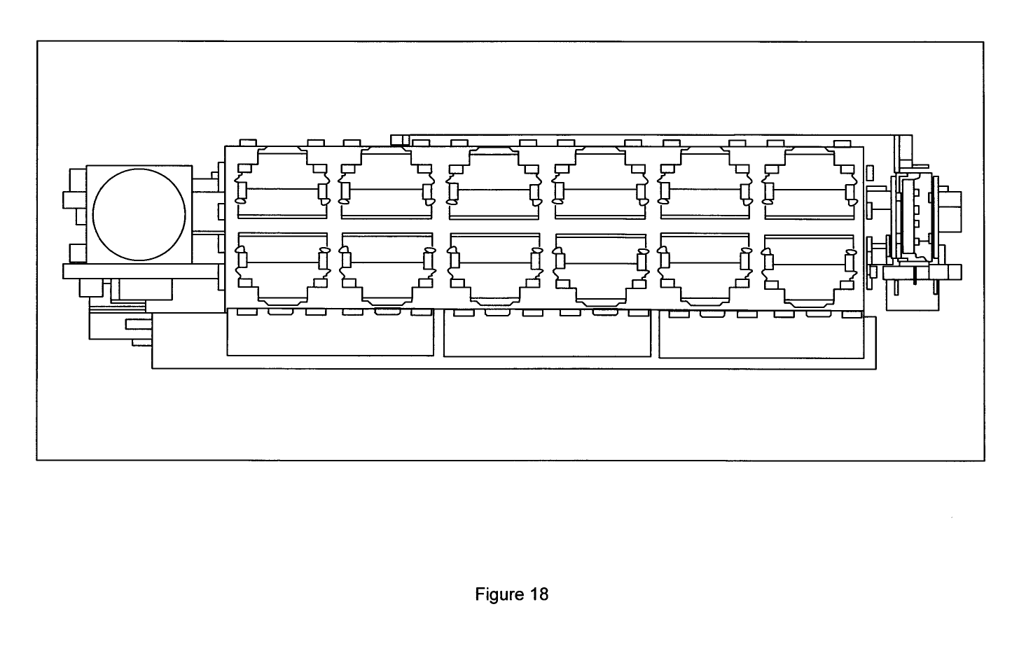

FIG. 18 depicts an exemplary front view of a carrier board for a hardware platform for virtualization.

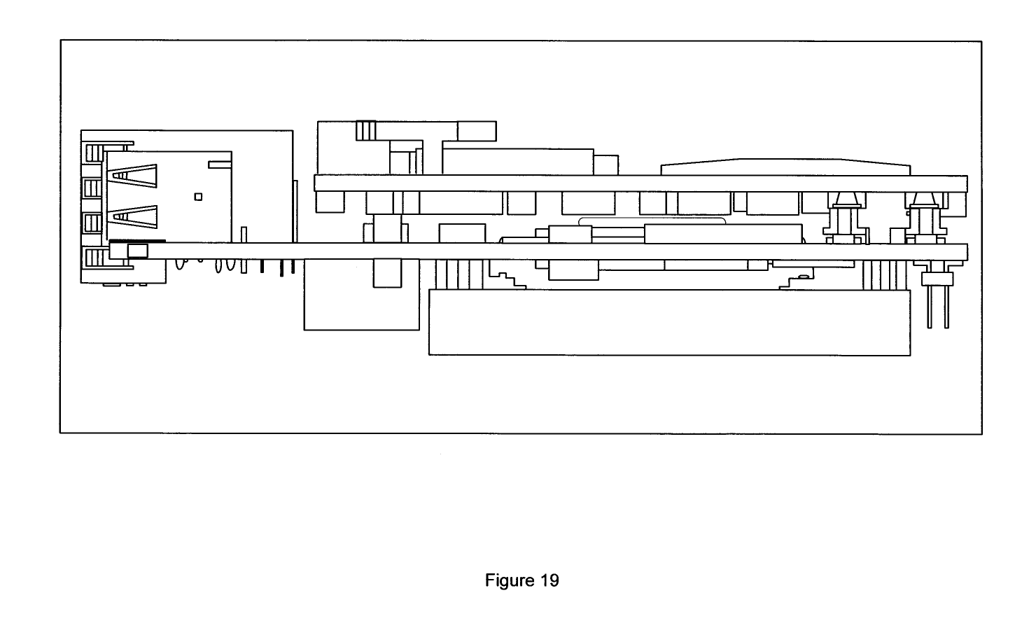

FIG. 19 depicts an exemplary side view of a carrier board for a hardware platform for virtualization.

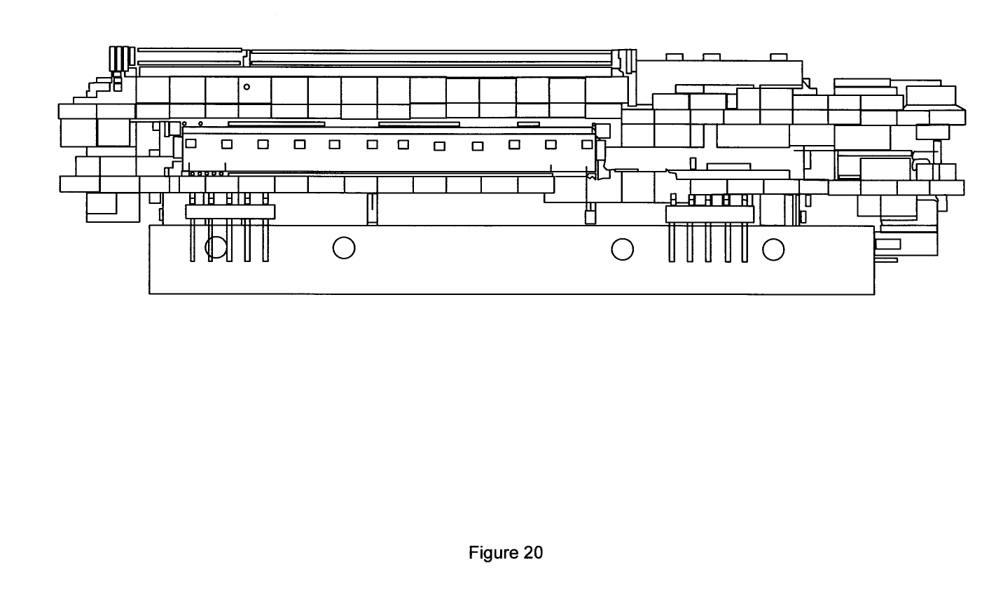

FIG. 20 depicts another exemplary side view of a carrier board for a hardware platform for virtualization.

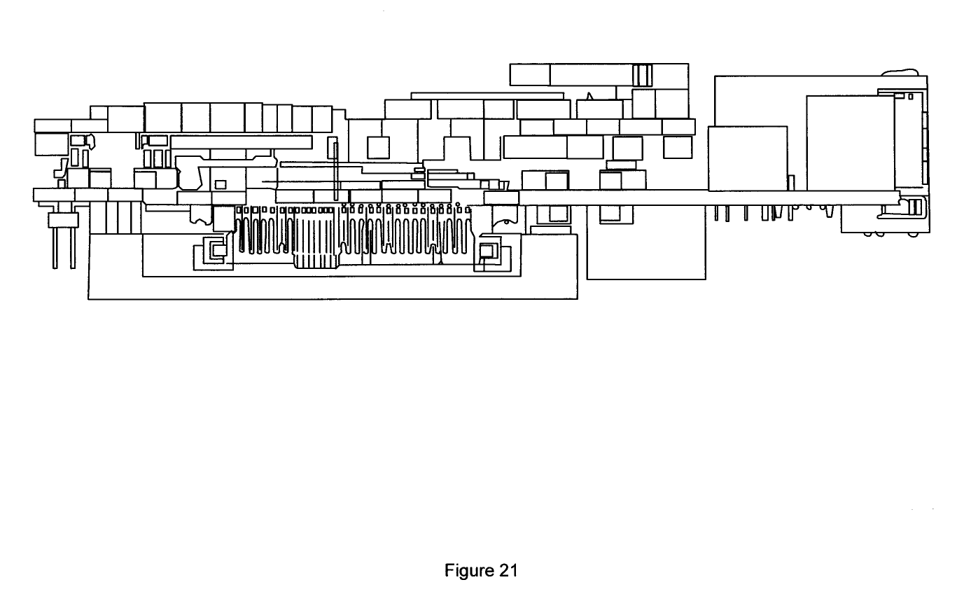

FIG. 21 depicts another exemplary side view of a carrier board for a hardware platform for virtualization.

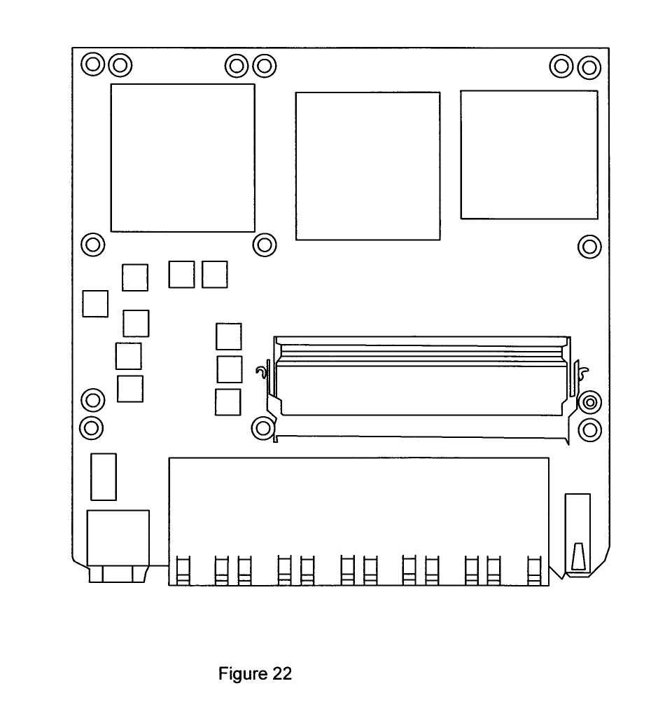

FIG. 22 depicts an exemplary top view of a carrier board for a hardware platform for virtualization.

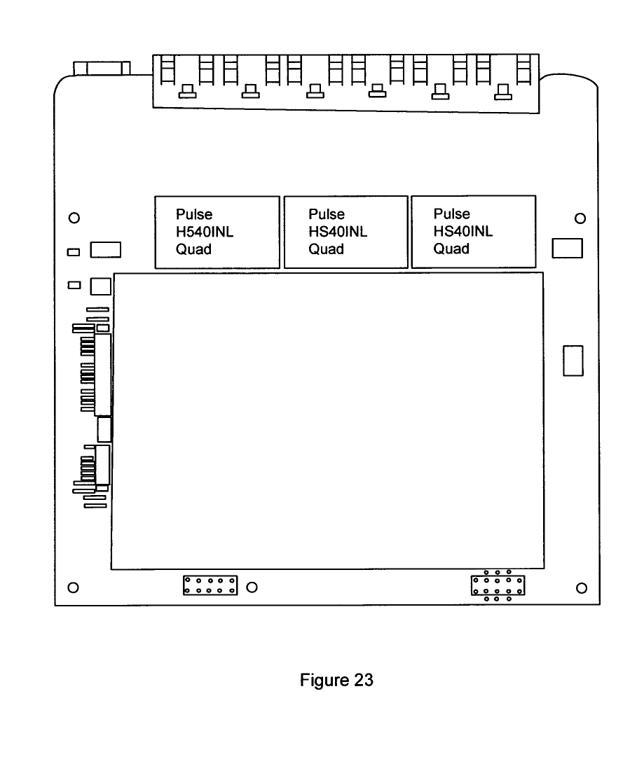

FIG. 23 depicts an exemplary bottom view of a carrier board for a hardware platform for virtualization.

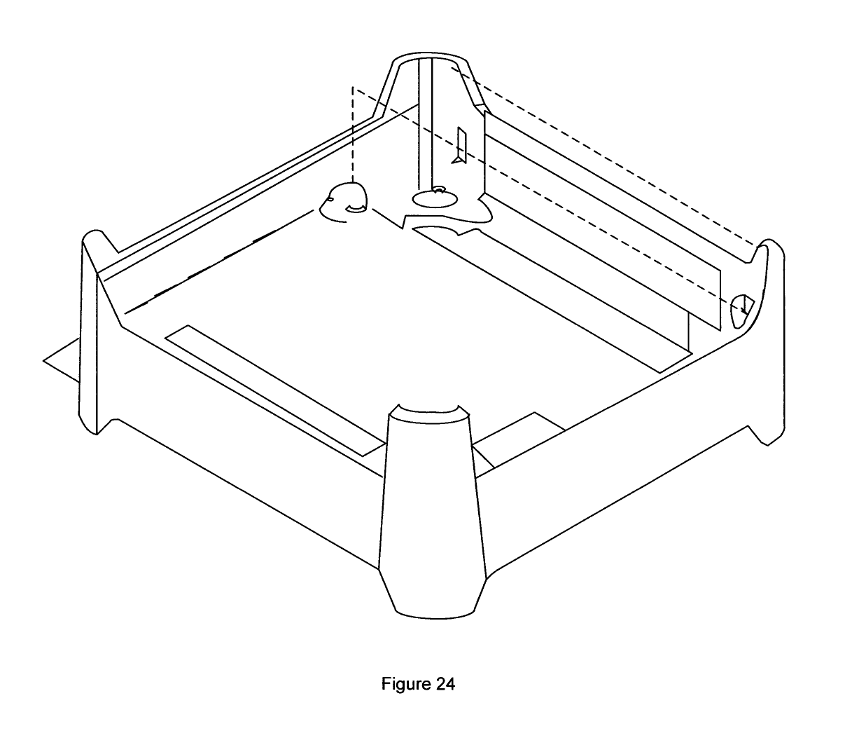

FIG. 24 depicts an exemplary view of a chassis of a hardware platform for virtualization.

In one or more embodiments, a hardware platform for enterprise level usage may be provided. For example, a rack mountable unit may be provided. Such as a EIA (Electronic Industries Alliance) −310 compliant rack mountable unit.

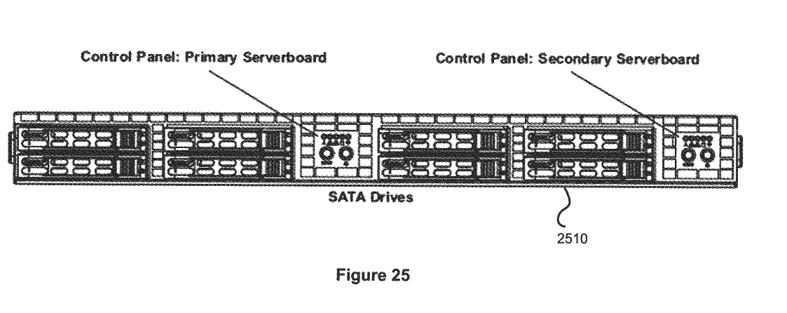

FIG. 25 depicts a front view of an additional exemplary hardware platform for virtualization. Virtualization platform 2510 may be a rack mountable unit such as a “1U” server utilizing one unit of rack space. Other configurations, such as a “2U” server or a “4U half-rack” server may be utilized. Virtualization platform 2510 may contain a plurality of server boards. For example, virtualization platform 2510 may contain server boards mounted side by side and the front panel may provide primary and secondary control panels. In some embodiments, a server from SuperMicron™, such as a SuperMicro SuperServer 1025TC-T or a SuperMicro SuperServer 1025TC-10G may be utilized. Specifications for the SuperMicro SuperServer 1025TC-T/1025TC-10G servers may be found in Appendix V of U.S. Patent Application No. 61/097,083. Exemplary circuitry for the SuperMicro SuperServer 1025TC-T/1025TC-10G servers may be found in Appendix VI of U.S. Patent Application No. 61/097,083. Virtualization platform 2510 may provide a IU rack mount system designed to increase computing density while reducing cost, energy and space requirements. Virtualization platform 2510 may provide two complete, enterprise class, server nodes into a 1RU form-factor and may deliver superior processing power density as compared to typical 1U and blade systems.

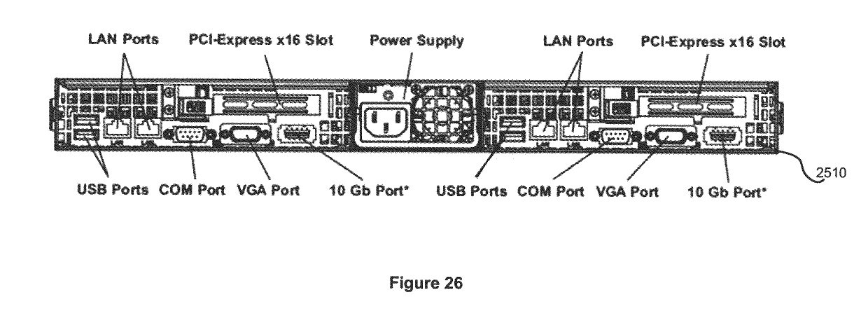

FIG. 26 depicts a rear view of an additional exemplary hardware platform for virtualization. Virtualization platform 2510 may provide access to one or more ports and/or interfaces of one or more server boards. As depicted in FIG. 26, interfaces may be provided via LAN ports, PCI-express slots, USB ports, COM ports, VGA Ports, 10 Gb Ports, and/or other interfaces.

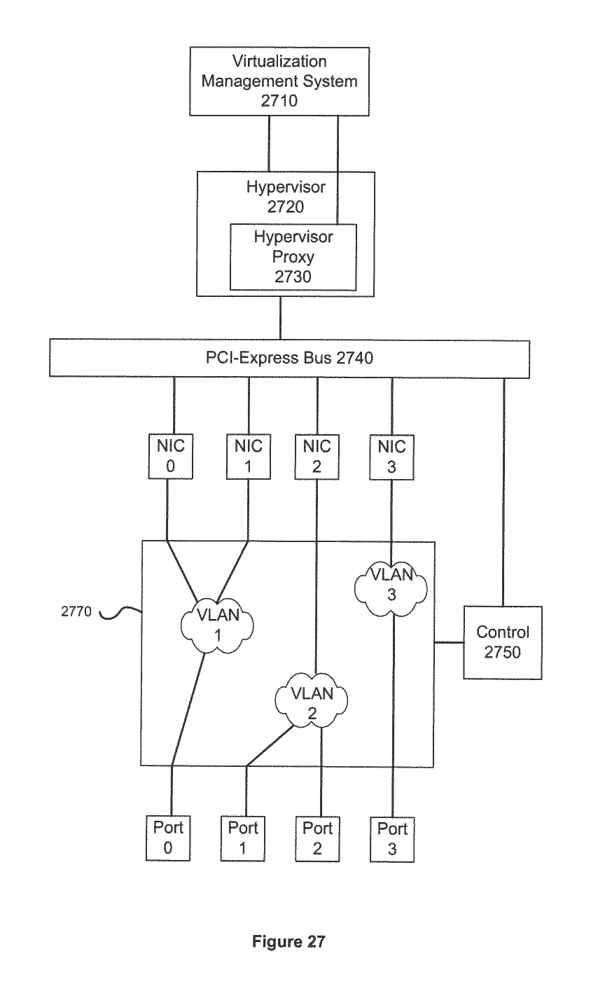

FIG. 27 depicts dynamic modification of physical network connectivity for a hardware platform, according to an exemplary embodiment. In one or more embodiments, a virtualization platform may contain multiple ports, such as NIC 0, NIC 1, NIC 2, and NIC 3, which may enable the creation of multiple physically independent subnets. A virtualization platform may allow creation and/or management of one or more virtual switches. NIC 0, NIC 1, NIC 2, and NIC 3 may be Network Interface Cards (NICs) used for subnetting within the virtualization platform. The use of virtual switches may enable the creation of one or more VLANs for a virtual environment. For example, managed layer 2 switch 2770 may be connected to one or more NICs and may enable the creation of one or more VLANs such as VLAN 1, VLAN 2, and VLAN 3. Managed layer 2 switch 2770 may also enable the connection of one or more VLANs to one or more external ports, such as Port 0, Port 1, Port 2, and Port 3. Virtualization management system 2710 may connect via hypervisor proxy 2730 to Hypervisor 2720. Hypervisor 2720 may access control 2750 via PCI-Express Bus 2740 or via another interface. In some embodiments, control 2750 may be a Field-Programmable Gate Array (FPGA) which may contain programmable logic components and programmable interconnects, such as, for example, an FPGA from Lattice Semiconductor Corporation or Altera Corporation. In some embodiments, control 2750 may be an Application-Specific Integrated Circuit (ASIC) or a Complex Programmable Logic Device (CPLD). Control 2750 may enable virtualization management system 2710 to manipulate managed layer 2 switch 2770. This may enable virtualization management system 2710 to perform VLAN creation, deletion and/or modification utilizing IEEE 802.1Q or VLAN tagging. Virtualization management system 2710 may create one or more virtual environments, utilize a virtual switch and the creation of a VLAN to expose the one or more virtual environments and their corresponding VLANs to one or more physical ports. For example, ports 1 and 2 may be associated with VLAN 2 and may provide redundant physical links for users to access a virtual environment associated with VLAN 2. Typically, a virtual switch is confined to a virtual environment. Virtualization management system 2710 may enable the configuration of a virtual switch to provide connectivity to one or more external ports, such as ports 0-3.

Virtualization platform 2510 may dynamically reconfigure a VLAN and/or a virtual switch to provide recovery for a physical outage, redundancy, and/or extra bandwidth capacity. For example, if VLAN 2 is originally configured to port 1 and an outage occurs or network throughput is degraded beyond an acceptable level, virtualization platform 2510 may dynamically reconfigure VLAN 2. Virtualization platform 2510 may utilize routing tables or other information to determine that port 2 is available and provides suitable network connectivity. Virtualization platform 2510 may then reconfigure VLAN 2 as depicted. Virtualization platform 2510 may also enable NIC teaming or link aggregation to enable more bandwidth to a virtual environment. For example, MC 0 and NIC 1 may be aggregated to provide additional bandwidth associated with VLAN 1. In some embodiments, dynamic configuration of physical network connectivity for a hardware platform may be referred to as “port mauling.”

In some embodiments, multiple networking components of FIG. 27 may be provided on a card. For example, a card, such as DSS Networks GigPCI-Express Switch Model 6468 as shown in Appendix VII of U.S. Patent Application No. 61/097,083 may provide multiple networking components.

In one or more embodiments of a virtualization platform, information indicators may be utilized to provide options, status or other information to a user. Informational indicators may provide the status of one or more attributes of the physical components of the virtualization platform.

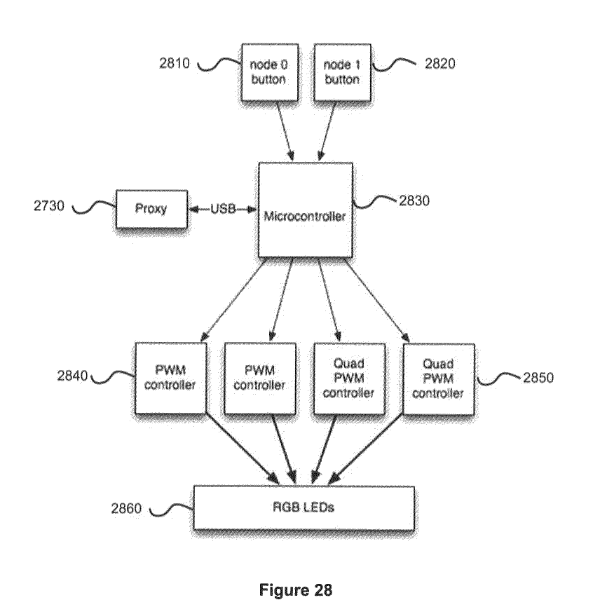

FIG. 28 depicts a logical diagram for connecting information indicators, according to an exemplary embodiment. Node 0 button 2810 and/or node 1 button may be buttons on a control panel of a virtualization platform, such the buttons on control panels associated with the primary and secondary serverboards of FIG. 25. Node 0 button 2810 and/or node 1 button may be communicatively coupled with microcontroller 2830. Microcontroller 2830 may be, for example, an Atmel AVR microcontroller. Proxy 2730 may also interface with microcontroller 2830 via a USB connection, an RS-232 serial connection, or another interface. Microcontroller 2830 may be communicatively coupled with one or more Pulse Width Modulation (PWM) controllers, such as PWM controller 2840 and quad PWM controller 2850. The controllers may be communicatively coupled to one or more RGB (Red, Green, Blue) LEDs (Light Emitting Diodes) 2860. Quad PWM controller may control up to four RGB LEDs. Controllers may be an integrated circuit such as a 3 channel constant current LED driver with programmable PWM control. For example, controllers may be an Allegro Microsystems, Inc. A6281. Other components may be utilized. Controllers may utilize a clocked serial interface and may permit a 10-bit brightness value, which may permit over a billion colors.

The interface between proxy 2730 and microcontroller 2830 may permit proxy 2730 to utilize RGB LEDs 2860 to display status information. The interface between microcontroller 2830 and node 0 button 2810 and/or node 1 button may enable a user to select one or more options. The options may be selected by toggling through utilizing multiple clicks of a button and leaving a hardware platform on a desired selection for more than a specified period of time. The options may also be selected by holding a button down while options are automatically iterated through and then releasing the button at the desired option. Options may be indicated by one or more predefined signals indicated by RGB LEDs 2860. In some embodiments, multiple RGB LEDs may be connected in series enabling an appearance of a scrolling indicator or an indicator displaying a gauge or a meter.

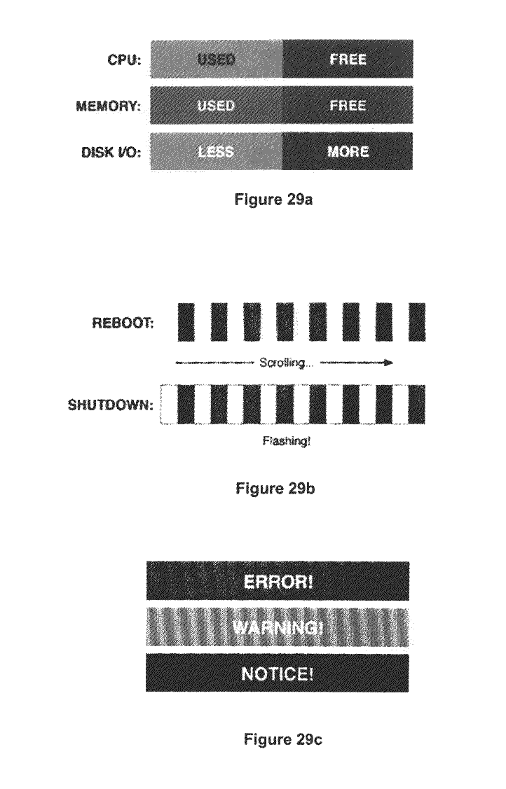

FIG. 29a depicts an exemplary information indicator display format. Different lighting may utilized in a series of RGB LEDs to indicate a level of a gauge or a meter. The contrast between the two or more colors used to indicate a first portion and a second portion of the series of LEDs may clearly indicate the level of utilization of one or more CPUs, of memory, of storage, disk input/output (I/O), network interface congestion, or other status indicators. Multiple indicators may be utilized to display different resource status indicators, or a single indicator may iterate through different displays. Displays may utilize different predetermined color schemes to indicate the status of different resources. In some embodiments, a user may toggle or iterate through status indicators using a button or other control.

FIG. 29b depicts an exemplary information indicator display format. Alternate RGB LEDs in a row of RGB LEDs may flash between two colors in a synchronized manner to create an appearance of scrolling. These predetermined patterns or other patterns may be utilized to offer different options to a user. For example, if a user holds down a button, a scrolling pattern of LEDs may indicate an option to reboot a computing platform. If the user releases the button, the computing platform may reboot. If the user keeps the button depressed the display may, after a predetermined time period, change to a different pattern to indicate a second option. For example, if a user holds down a button, a first scrolling pattern may indicate a reboot option. After ten seconds of keeping the button depressed, the display may change to a flashing pattern indicating a shutdown option. If the user releases the button during this display, the hardware platform may shutdown. Other user controls interfaces, such a multiple buttons, may be utilized.

FIG. 29c depicts an exemplary information indicator display format. Information indicators may be utilized to display alerts. Different patterns or formats of alerts may be utilized to indicate different classes or levels of alerts. For example, a first color may indicate an error condition, a second color may indicate a warning and a third color may indicate a notice. A user may utilize a monitor associated with the computing platform for more detail. A user may also be able to address a condition by taking one or more actions such as rebooting. Referring again to FIG. 28, a virtualization management system may monitor one or more virtualization platform statuses and may utilize proxy 2730 to manipulate one or more of RGB LEDs 2860 to provide status indicators, warnings, errors, notices, alerts, and/or options. In some embodiments, a brightness or a speed of flashing or scrolling may indicate a level of severity of an alert, error, and/or warning. Other patterns may be utilized.

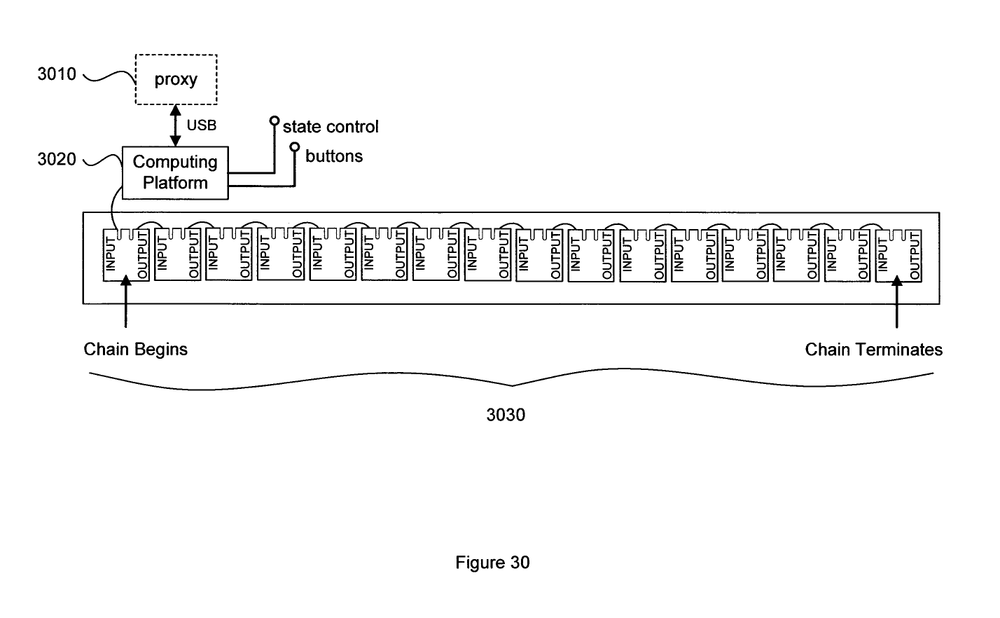

FIG. 30 depicts a logical diagram for connecting information indicators, according to an exemplary embodiment. Series 3030 may represent multiple RGB LEDs connected sequentially in a series. The RGB indicators may be RGB modules coupled with an Pulse Width Modulation (PWM) controller which may receive a clocked serial input and may pass the output to the next RGB module in the series. In one or more embodiments, the RGB modules may be Shiftbrite modules as described in Appendix VIII of U.S. Patent Application No. 61/097,083. Computing platform 3020 may be a board with a microprocessor, a voltage regulator, a oscillator or resonator, one or more interface circuitry components, and/or other components. In some embodiments, computing platform 3020 may be an Arduino, or another electronics platform. Proxy 3010 may be a hypervisor proxy utilized by a virtualization management system. Proxy 3010 may interface with computing platform 3020 via a USB interface an RS-232 serial interface or other interfaces. Computing platform 3020 may be communicatively coupled with one or more RGB LEDs, such as series 3030. Series 3030 may enable a chain of two or more RGB LEDs. Proxy 3010 may utilize a communications code for controlling one or more RGB LEDs or information indicators via computing platform 3020. Appendix IX of U.S. Patent Application No. 61/097,083 provides exemplary information indicators communication code.

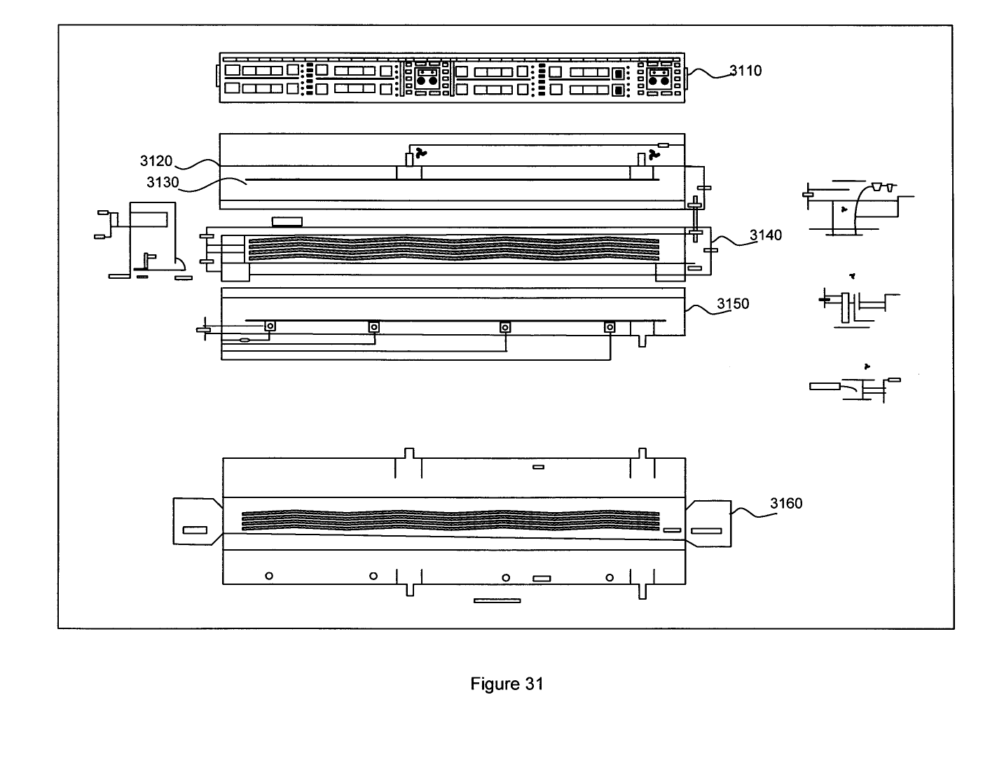

FIG. 31 depicts a bezel for mounting information indicators on a hardware platform, according to an exemplary embodiment. Virtualization platform 3110 depicts a virtualization platform, such as virtualization platform 2510 described in reference to FIG. 25 above. Virtualization platform 3110 may be a virtualization platform without a bezel. Bezel 3120 may depict a top view of a bezel containing RGB LEDs 3130. Bezel 3120 may be designed for mounting on virtualization platform 3110. Bezel 3150 may be a top view of a bezel. Element 3160 may be a bezel cover containing a pattern of perforations, such as a honeycomb pattern. Element 3140 may be a front view of a bezel with a bezel cover in place. Information indicators in element 3140 may be communicatively coupled as discussed in reference to FIG. 28 above.

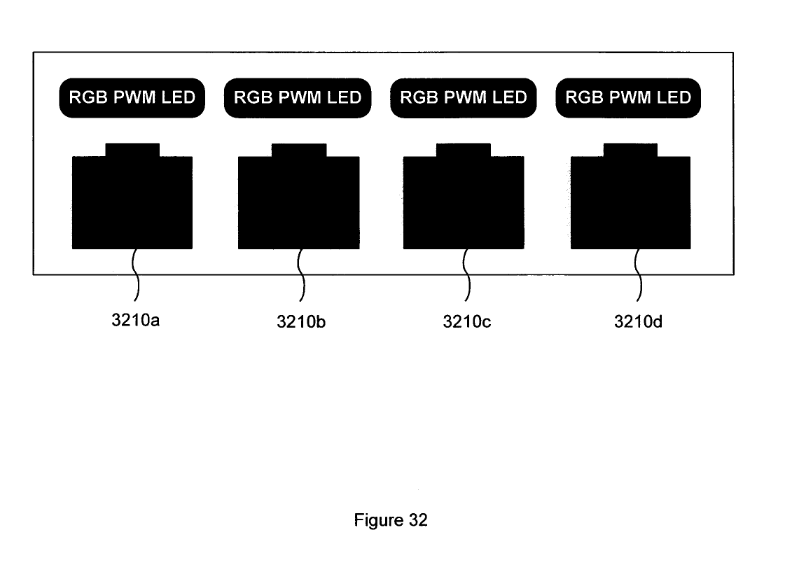

FIG. 32 depicts exemplary information indicators associated with network ports. In some embodiments, one or more information indicators, such as RGB LEDs, may be associated with a network port. Information indicators may enable a clear indication of a VLAN a port is associated with, a subnet a port is associated with or other attributes. As discussed above in reference to FIG. 27, a hardware platform may enable dynamic configuration of physical network connectivity for that platform, or port mauling. Since physical ports may be dynamically reconfigured to be associated with different subnets of the computing platform, different VLANs of the computing platform, or other configurations, static network labels on a port may not be adequate. Information indicators which may communicatively coupled as discussed in reference to FIG. 28 above. As an example, port 3210a may correspond to port 0 in FIG. 27. Ports 3210b, 3210c and 3210d may correspond to port 1, port 2, and port 3 respectively. Port 3210a may be associated with an information indicator of a first color indicating that it is associated with VLAN 1 of FIG. 27. Port 3210b and 3210c may be associated with an information indicator of a second color indicating that they are associated with VLAN 2. Port 3210d may be associated with an information indicator of a third color indicating that it is associated with VLAN 3. Virtualization management system 2710 may dynamically change the display of one or more information indicators or RGB Pulse Width Modulation (PWM) LEDs associated with port 3210a, port 3210b, port 3210c and/or port 3210d. Virtualization management system 2710 may change the display of the information indicators as ports are reconfigured or as statuses change.

Information indicators may also display physical status information associated with a port. Information indicators may be used for training or for problem identification and location. A server technician in a crowded server room may easily identify a hardware platform with an error by spotting indicators with a predefined error display on the bezel of a hardware platform. The technician may then easily identify a port on the back of the hardware platform with an error condition by spotting an information indicator associated with the port.

According to some embodiments, information indicators may incorporate similar color or lighting patterns to those of a virtualization management system user interface. For example, a user in a server room may identify a computing platform with an issue by spotting a pattern on one or more information indicators on the bezel of the computing platform. The user may examine information indicators associated with one or more ports on the back of the computing platform. The information indicators may display different lighting schemes, such as different colors, to indicate VLANs and/or subnets that a port is associated with. The information indicators may also provide other status information, such as blinking or constant to indicate a status. Color schemes and lighting patterns may be predetermined and may be adjustable by an administrator of a virtualization management system. In this example, the user may know that a blinking information indicator indicates trouble. The user may identify a blinking information indicator and may then access the user interface of a virtualization management system, such as a user interface as depicted in FIGS. 4a, 4b, and 4c. The user interface may display a network topology containing one or more portions corresponding to color schemes on the ports. If the user determines that a port associated with a blue information indicator is blinking and experiencing difficulty, the user may determine via the user interface that the blue port corresponds to a particular VLAN displayed in blue. This may enable a user to walk into a server room and quickly and intuitively identify a problem by spotting one or more external information indicators on a computing platform. The user may look at further information indicators, such as information indicators associated with ports, or may utilize a user interface to drill down and further diagnose the issue.

In some embodiments, information indicators may be associated with additional interfaces, such as interfaces for peripheral devices. For example, information indicators may be associated with USB interfaces, SCSI interfaces, RS-232 interfaces, firewire interfaces or other interfaces. Information indicators may display status information associated with external storage or other devices. Status information may include available capacity, errors, warnings, or other attributes associated with an attached device.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. An apparatus for providing virtualization services, comprising:
a middle chassis for containing one or more computing components for providing virtualization services;
a top chassis for covering the middle chassis, wherein the top chassis includes a heat sink for conducting thermal energy away from the one or more computing components contained in the middle chassis, and wherein the top chassis is capable of being securely fastened to the middle chassis; and
a bottom chassis providing a base for the apparatus and a covering for the bottom of the middle chassis, wherein the bottom chassis includes a heat sink for conducting thermal energy away from the one or more computing components contained in the middle chassis, and wherein the bottom chassis is capable of being securely fastened to the middle chassis;
a carrier board for securing one or more components, the carrier board communicatively coupling the one or more computing components and the carrier board being capable of being securely fastened to the middle chassis; and
one or more thermally conductive layers fastened to one or more components of the carrier board, wherein the one or more thermally conductive layers provide additional thermal conductivity for the one or more components.

2. The apparatus of claim 1, wherein the carrier board is COM Express basic form factor carrier board.

3. The apparatus of claim 1, wherein the middle chassis further comprises a heatsink for conducting thermal energy away from the one or more computing components.

4. The apparatus of claim 1, wherein the middle chassis contains one or more vents for improving air circulation inside the apparatus.

5. The apparatus of claim 1, wherein at least one of the components is a processor.

6. The apparatus of claim 1, wherein the one or more thermally conductive layers comprise at least one of: a copper spreader layer, a composite solder layer, a phase change thermal interface layer, a thermal gap filler layer, and a combination of the preceding.

7. The apparatus of claim 2, further comprising an Ethernet switch operably coupled to the carrier board.

8. The apparatus of claim 7, wherein at least one port of the Ethernet switch is communicatively coupled to an integrated port of the carrier board and at least one port of the Ethernet switch is communicatively coupled to an external RJ-45 port.

9. The apparatus of claim 7, further comprising a plurality of Ethernet controllers.

10. The apparatus of claim 9, wherein a component of at least one of the Ethernet controllers enables access to remote storage providing a network bootable platform.

11. The apparatus of claim 9, wherein the access to remote storage utilizes iSCSI permitting access to remote SCSI targets.

12. An apparatus for indicating one or more computing platform conditions comprising:
a microcontroller communicatively coupled to a computing platform;
one or more pulse width modulation controllers communicatively coupled to the microcontroller, wherein the one or more pulse width modulation controllers utilize a clocked serial interface; and
one or more light emitting diodes communicatively coupled to the one or more pulse width modulation controllers.

13. The apparatus of claim 12, wherein the one or more light emitting diodes are RGB (Red, Green, Blue) Light Emitting Diodes.

14. The apparatus of claim 13, wherein the one or more pulse width modulation controllers permit a 10-bit brightness value for setting the one or more light emitting diodes.

15. The apparatus of claim 12, wherein the one or more light emitting diodes are mounted on bezel of a computing platform.

16. The apparatus of claim 15, wherein the microcontroller is communicatively coupled to one or more user input controls permitting a user to select a computing platform condition statuses to be indicated by the one or more light emitting diodes.

17. The apparatus of claim 16, wherein the condition statuses to be indicated include at least one of: available memory, available storage, available CPU, disk input/output, temperature, error, warning, notice, startup, shutdown, powersave, or a combination of the preceding.

18. The apparatus of claim 17, wherein the severity of a status may be indicated by at least one of: a light emitting diode brightness, a light emitting diode color, light emitting diode display pattern, a flashing light emitting diode, scrolling light emitting diodes, or a combination of the preceding.
